(19) United States
(12) Patent Application Publication
(10) Pub. No.: US 2026/0066715 A1
(43) Pub. Date: Mar. 5, 2026

(54) MEMORY MACHINE WITH MULTIPLE LOW COERCIVE FORCE MAGNETS

(71) Applicant: DANA TM4 INC., Boucherville (CA)

(72) Inventors: Benoit BLANCHARD ST-JACQUES, Boucherville (CA); Ruisheng SHI, Montreal (CA)

(21) Appl. No.: 19/291,367

(22) Filed: Aug. 5, 2025

Related U.S. Application Data
(60) Provisional application No. 63/689,127, filed on Aug. 30, 2024.

(51) Int. Cl. H02K 1/02; B60K 1/00; H02K 1/276; H02K 21/14

(52) U.S. Cl. CPC H02K 1/02; H02K 1/276; H02K 21/14; B60K 1/00

(57) ABSTRACT

Systems are provided a rotor and magnets of a system of an electric machine that is a variable flux machine (VFM), such as a memory machine or memory motor (MM). The rotor of the system, comprising: a first set of magnets with higher coercivity integrated in at least a slot of the rotor to be arranged in a V-shape; and a second set of magnets with a lower coercivity, compared to the first set of magnets, the second set of magnets comprising at least a pair of magnets of different grades arranged in parallel in a radial slot of the rotor, where the first set of magnets forms a first magnetic layer and the second set of magnets forms a second magnetic layer of the rotor.

### CROSS REFERENCE TO RELATED APPLICATIONS

The present application claims priority to U.S. Provisional Application No. 63/689,127, entitled “MEMORY MACHINE WITH MULTIPLE LOW COERCIVE FORCE MAGNETS”, and filed on Aug. 30, 2024. The entire contents of the above-listed application are hereby incorporated by reference for all purposes.

### TECHNICAL FIELD

The present description relates generally to an electric machine, and more specifically a variable flux machine, where the arrangement allows for the rotor of the electric machine to be free of rare-earth permanent magnets.

### BACKGROUND AND SUMMARY

Variable flux machines (VFM) are electric machines, such as electric motors and/or generators, that may dynamically change the intensity of magnetization, via increasing or decreasing magnetic current, and memorize the flux density levels of magnets housed via a rotor of the VFM. VFMs may therein additionally and alternatively be referred to as memory electric machines or memory machines (MMs), such as memory motors and/or memory generators. VFMs may be used to generate torque or electrical energy in machines or systems, such as in electric vehicles (EVs), including fully electric vehicles (FEVs) and hybrid electric vehicles (HEVs) with multiple sources of torque from at least an electric machine. VFMs allow for wider and more variable ranges (e.g., envelopes) of torques and rotational speeds when compared with other electric machines for driving or electrically powering a system, such as interior permanent magnet synchronous motors (IPMSMs).

There is a desire to manufacture and use VFMs and MMs that are free of rare-earth metals/materials, referred to herein as rare-earths. Rare-earths may be scarce in supply and difficult to obtain/secure, and therein subject to volatile availability and costs for procurement. Additionally, there may be a specific desire to reduce environmental degradation that come with the procurement of rare-earths, such as via mining or precipitate extraction, and refinement of rare-earths. Existing MMs and other VFMs free of rare-earth magnets, such as rare-earth permanent magnets, may experience loading de-magnetization leading to degradation or abrupt ceasing of operations for the VFMs. Further, existing MMs and other VFMs free of rare-earths, may have lower utilization of reluctance torque, reducing the efficiency converting mechanical energy to electrical energy and vice versa. The problems for rare-earth free VFMs may be due in part to low coercivity of the adopted magnets. In addition, rare-earth-free MMs often include a single type of magnet. Hybrid magnet VFMs are often built with high coercivity and low coercivity magnets coexisting in the same magnetic circuit (MC). There is a desire for hybrid magnet VFMs free of rare-earths with high and low coercivity magnets.

The inventors have recognized drawbacks to VFM configurations free of rare-earth permanent magnets, such as those described above. The inventors have therein developed an embodiment of a solution that includes a rotor of a system of an electric machine, comprising: a first set of magnets with higher coercivity integrated in at least a slot of the rotor to be arranged in a V-shape; and a second set of magnets with a lower coercivity, compared to the first set of magnets, the second set of magnets comprising at least a pair of magnets of different grades arranged in parallel in a radial slot of the rotor, where the first set of magnets forms a first magnetic layer and the second set of magnets forms a second magnetic layer of the rotor.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows an example schematic representation of a system, including an electric drive system;

FIG. 2 shows an electric machine system and an end view of an example of an electric machine of the present disclosure;

FIG. 3 shows a schematic diagram and sectional perspective of the electric machine;

FIG. 4 shows an exploded view of an assembly including a stator, a rotor, and a plurality of permanent magnets of the present disclosure;

FIG. 5 shows a sectional view of the assembly;

FIG. 6 shows a sectional view of the rotor;

FIG. 7 shows a sectional view of a sectioned segment of the assembly;

FIG. 8A shows a sectional view of the sectioned segment during a first mode;

FIG. 8B shows a sectional view of the sectioned segment during a second mode;

FIG. 8C shows a sectional view of the sectioned segment during a third mode;

FIG. 9 shows a plurality of traces for a plurality of magnetic materials of permanent magnets housed by the assembly, the traces showing magnetic flux densities at different magnetic field strengths (H)

FIG. 10 shows a trace of a de-magnetization curve for the electric machine, where the trace shows magnetic flux at different de-magnetizing currents.

FIG. 11 shows a plurality of traces of de-magnetization curves for the magnetic materials, where the traces show de-magnetization ratios at different de-magnetization currents.

FIG. 12 shows a radar chart with a plurality of traces of magnetic flux density for the magnetic materials at different conditions.

FIG. 13 shows a graph with a plurality of traces showing re-magnetization curves for the electric machine.

FIG. 14 shows a graph with a plurality of traces showing re-magnetization curves for the magnetic materials, where the traces show de-magnetization ratios at different magnetization currents.

FIG. 15 shows a graph of a plurality of traces of back-electromagnetic force (back-EMF) over time for magnetization states of the electric motor.

FIG. 16 shows a graph of traces of torque relative to current for different current angles.

FIG. 17 shows a graph of a plurality of traces of energy from torque at different current angles for different torques of the electric machine.

FIG. 18 shows a graph of a plurality of traces of energy from torque at different current angles for different torques of the electric machine.

FIG. 19 shows a graph of a plurality of traces that show energy from torque over time for different magnetization states.

### DETAILED DESCRIPTION

The following description relates to systems for a rotor of an electric motor. The rotor comprises rotor of a system of an electric machine, comprising: a first set of magnets with higher coercivity integrated in at least a slot of the rotor to be arranged in a V-shape; and a second set of magnets with a lower coercivity, compared to the first set of magnets, the second set of magnets comprising at least a pair of magnets of different grades arranged in parallel in a radial slot of the rotor, where the first set of magnets forms a first magnetic layer and the second set of magnets forms a second magnetic layer of the rotor.

The first set magnets may be arranged in a V-shape via a V-shaped structure or structures, such as the slot or a plurality of slots. More specifically, the first set of magnets may include a plurality of sub-sets with each sub-set being arranged in a V-shape. Each sub-set may be at least a pair of magnets. Said in another way, each sub-set may include at least two magnets. The first set of magnets may act as the main/series flux path producer. The first set of magnets are the higher coercivity (HC) magnets imbedded in the rotor.

The flux from the first set of magnets may flow through at least a parallel hybrid spoke structure with two low coercivity (LC) magnets, where each of the LC magnets are of different grades of material and coercivity. There is a plurality of magnets of a second set of magnets including the two LC magnets. The spoke shaped branch is structured with a flux barrier support for minimizing the flux shortening effect near the magnet edges. The two LC magnets are connected in parallel to form a magnetic circuit (MC). Likewise, the two LC magnets are of different de-magnetization characteristics, where a first LC magnet of the two LC magnets has a lower coercivity than the other LC magnet of the two LC magnets. The two LC magnets include a first LC magnet and a second LC magnet, where the first LC magnet top parallel magnet (e.g., a magnet that is the furthest radially outward) and the second LC magnet is bottom parallel magnet (e.g., the magnet that is the closest radially inward). The first LC magnet is the weaker magnet in the MC. While, the second LC magnet is stronger than the first LC magnet. The proposed parallel structure of the MC enhances the flux regulation by enabling the cross-coupling de-magnetization effect of the spoke structures. The parallel hybrid features of VFM including the rotor system, the first set of magnets, and the second set of magnets, are obtained using rare-earth material free magnets. The strongest magnets are adopted for the V-shaped structure and first set of magnets for achieving a desired loading de-magnetization withstanding capability.

The first set of magnets arranged in the V-shape for the rotor, may be made of an Iron-Nitride (FeN) magnet material which may have desired de-magnetization characteristics compared to Aluminum, Nickle, Cobalt alloy (AlNiCo) magnets. The second set of magnets connected in parallel to form the MC are made of two different grades of AlNiCo magnets, where the first LC magnet is a different grade of AlNiCo from the second LC magnet. The FEN magnets may enable the electric machine to utilize a high reluctance torque which may achieved by using AlNiCo magnets due to its reduced coercivity.

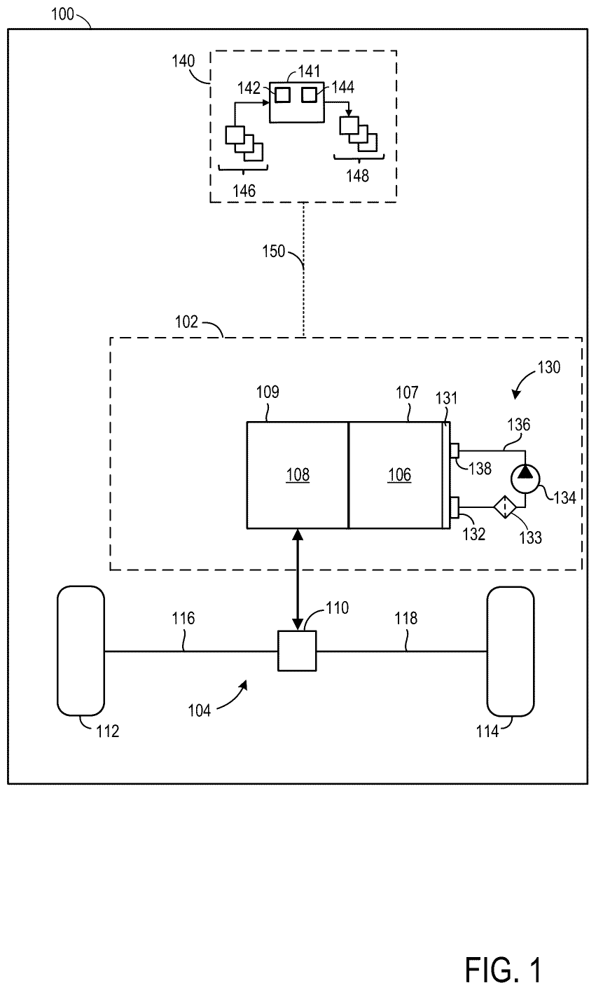

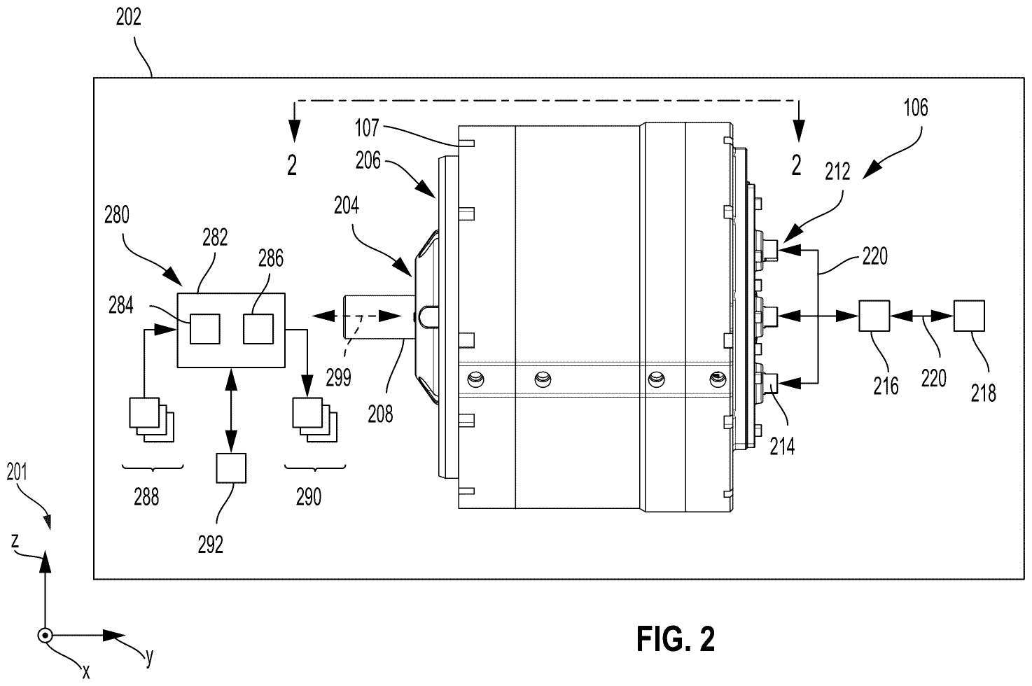

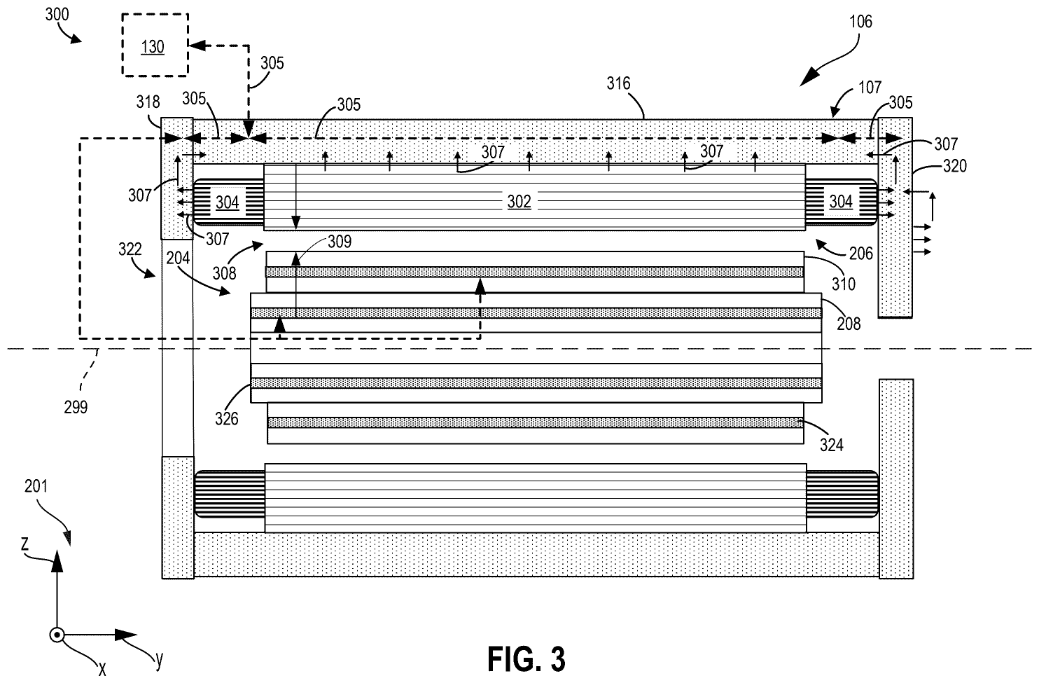

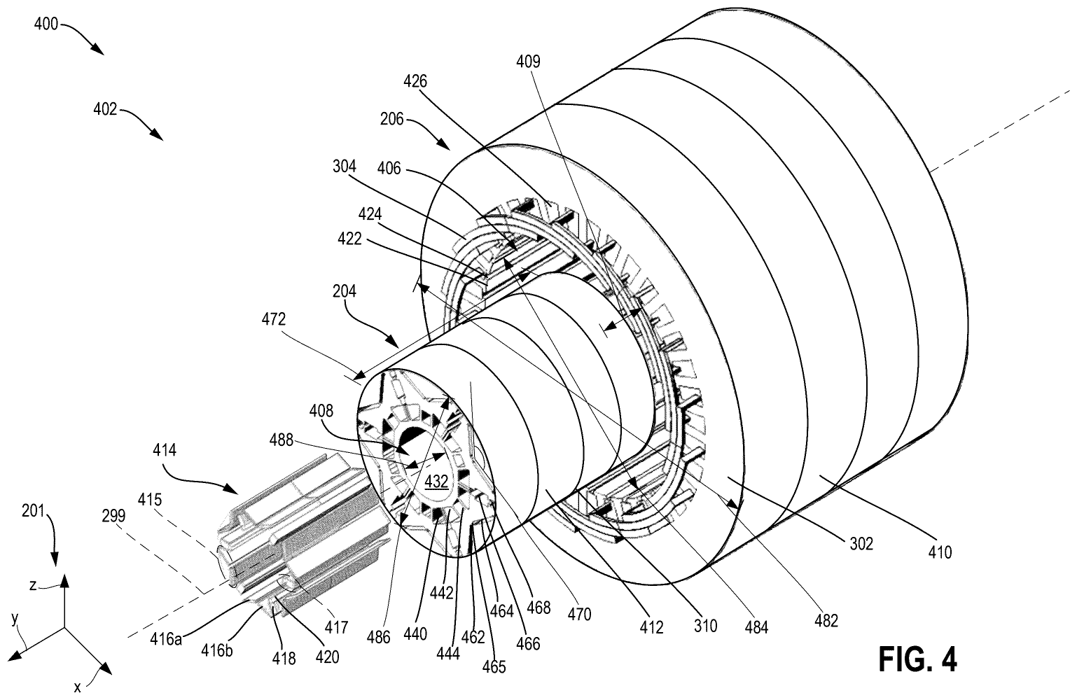

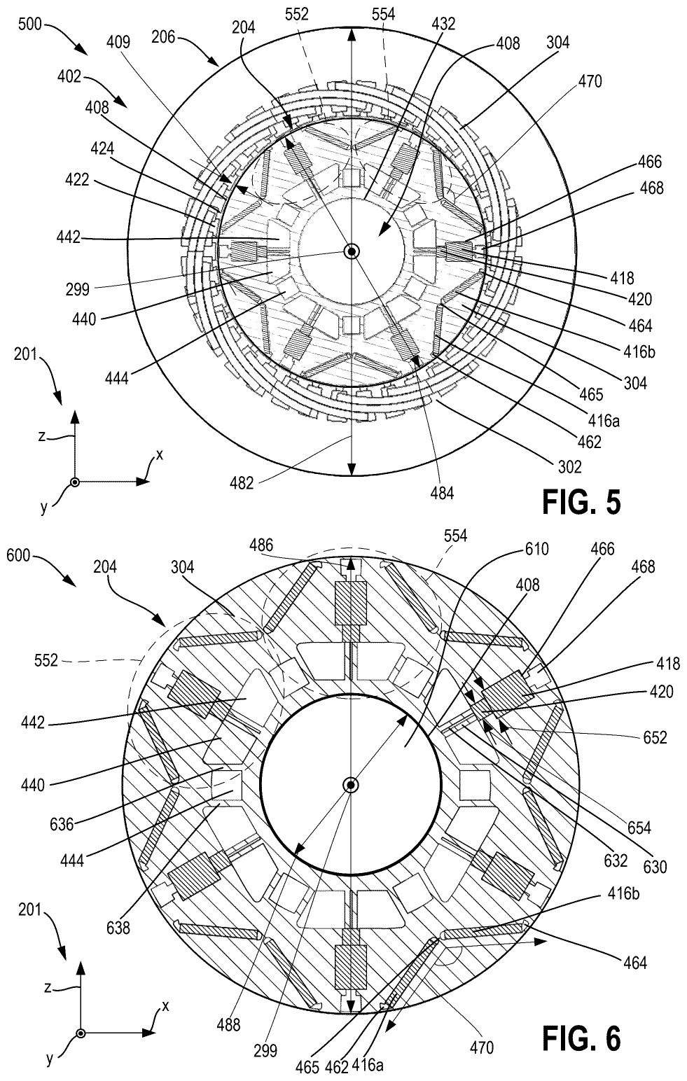

FIG. 1 shows an example schematic representation of a system, including an electric drive system. The electric drive system of FIG. 1 includes an electric machine of the present disclosure, where the electric machine may be a Variable flux machines (VFM) and a memory machine (MM) that drives the system via mechanical energy. The system of FIG. 1 may be a vehicle. FIG. 2 shows an electric machine system and an end view of an example of an electric machine of the present disclosure. The electric machine of FIG. 2 is the electric machine of FIG. 1. FIG. 3 shows a schematic diagram and sectional perspective of the electric machine. FIG. 4 shows an exploded view of an assembly including a stator, a rotor, and a plurality of permanent magnets of the present disclosure. The configuration of the assembly shown in FIG. 4 allows for the permanent magnets to be free of rare-earth materials. Said in another way, the configuration of the assembly shown in FIG. 4 allows for a VMF free of rare-earth permanent magnets. The permanent magnets include a plurality of first sets of magnets that are higher coercivity (HC) and a plurality of second sets of magnets that are lower coercivity (LC). Each of the second sets of magnets include a pair of magnets arranged to be connected in parallel as a magnetic circuit (MC), of material, where each magnet of the pair is of different coercivities and comprises different grades of material. The magnets of the second set of magnets include a first LC magnet and a second LC magnet, where the first LC magnet is a lower coercivity than the second LC magnet. FIG. 5 shows a sectional view of the assembly. FIG. 6 shows a sectional view of the rotor. FIGS. 5-6 show the first sets of magnets of the permanent magnets arranged in a V-shape and integrated into the rotor via a plurality of slots, where the slots are arranged into a V-shaped structure. Likewise, FIGS. 5-6 show the magnets of the second sets of magnets connected in MC in a parallel configuration and integrated into the rotor via a plurality of other slots, where the other slots arrange the magnets of the second sets of magnets into pairs and a spoke shape. Each pair of magnets in the second set includes a first lower coercivity magnet and a second lower coercivity magnet, where the first lower coercivity magnet is on top of and radially outward relative to the second lower coercivity magnet. The first lower coercivity magnet has a lower coercivity compared the second lower coercivity magnet, and therein the second lower coercivity magnet may be magnetically stronger compared to the first lower coercivity magnet.

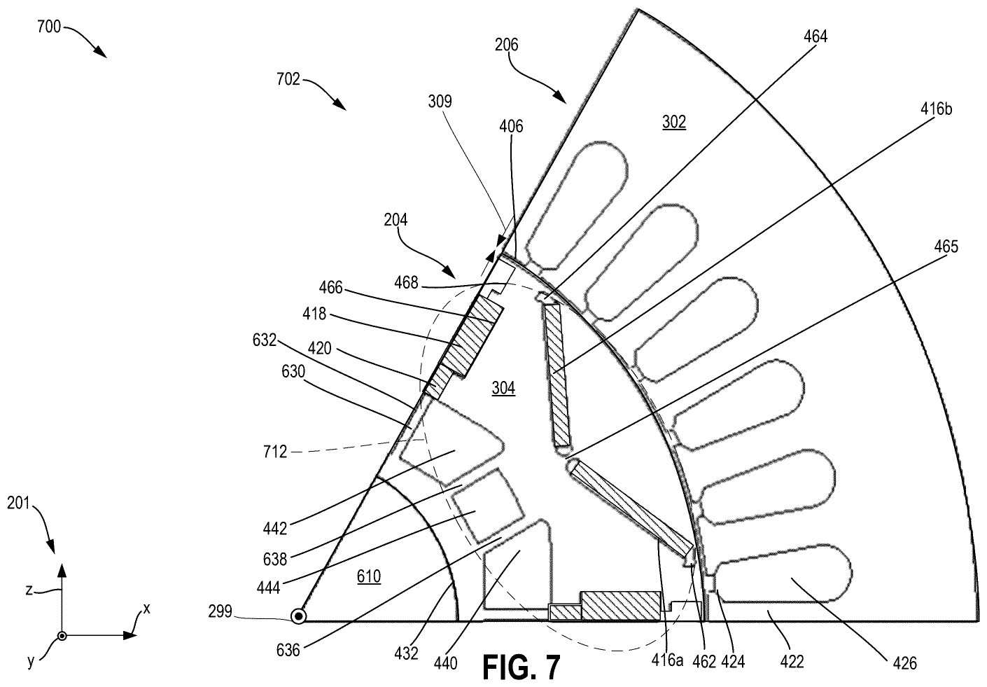

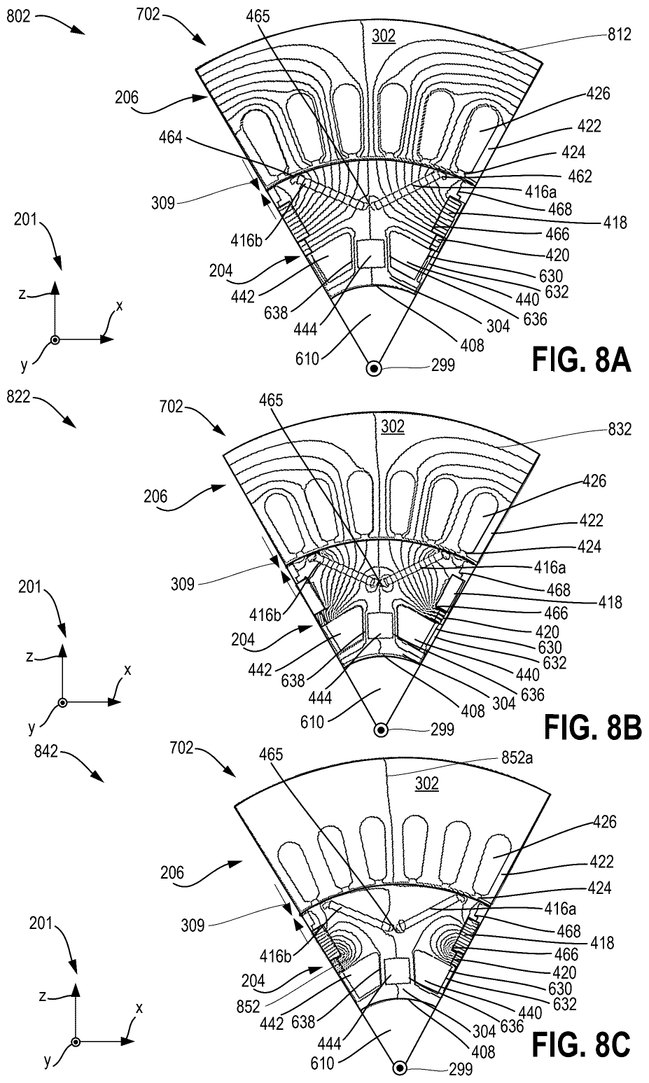

FIG. 7 shows a sectional view of a sectioned segment of the assembly. FIG. 8A shows a sectional view of the sectioned segment during a first mode. FIG. 8B shows a sectional view of the sectioned segment during a second mode. FIG. 8C shows a sectional view of the sectioned segment during a third mode.

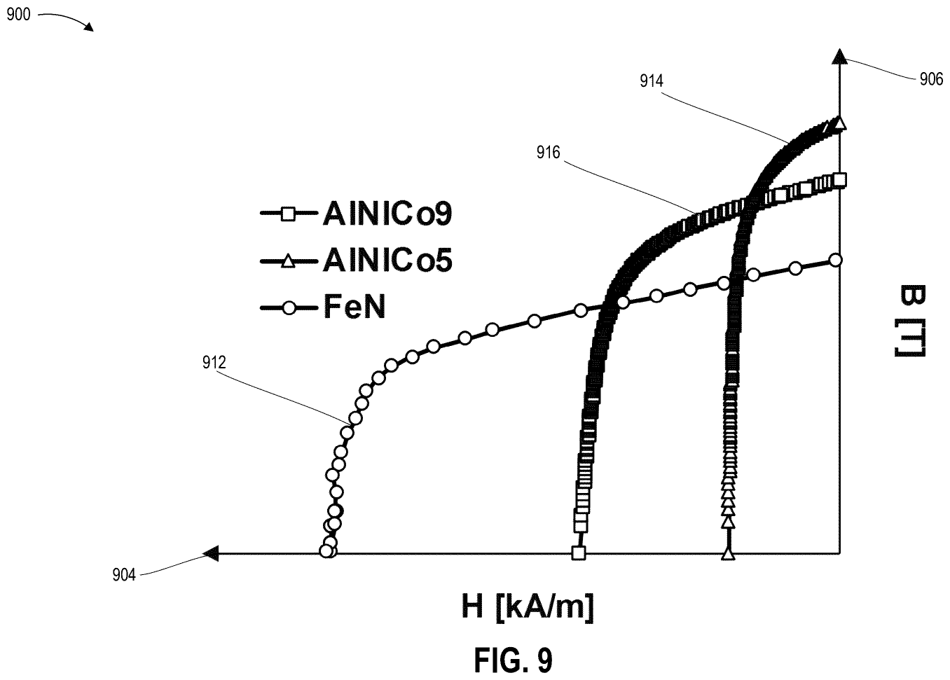

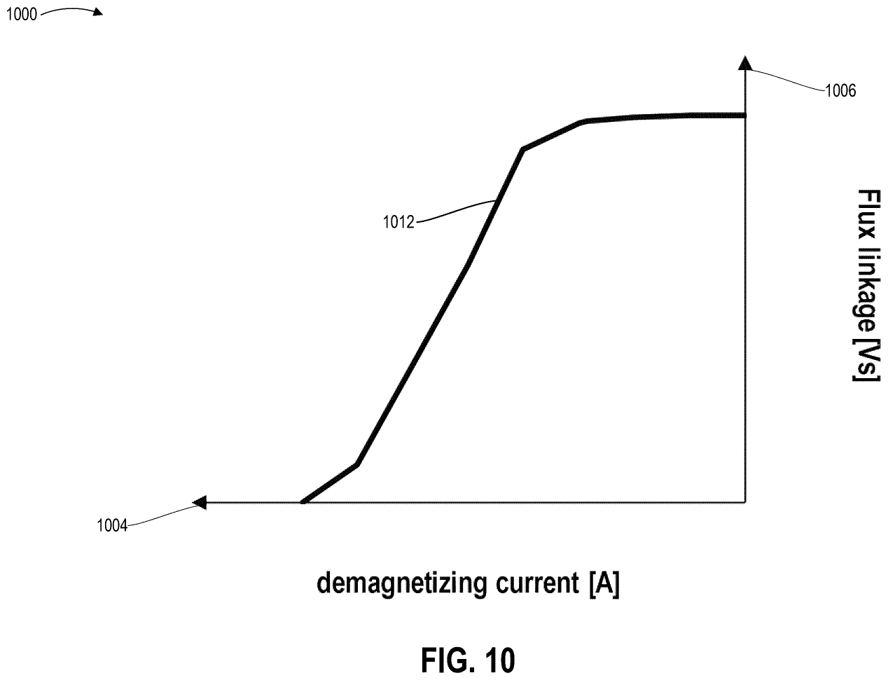

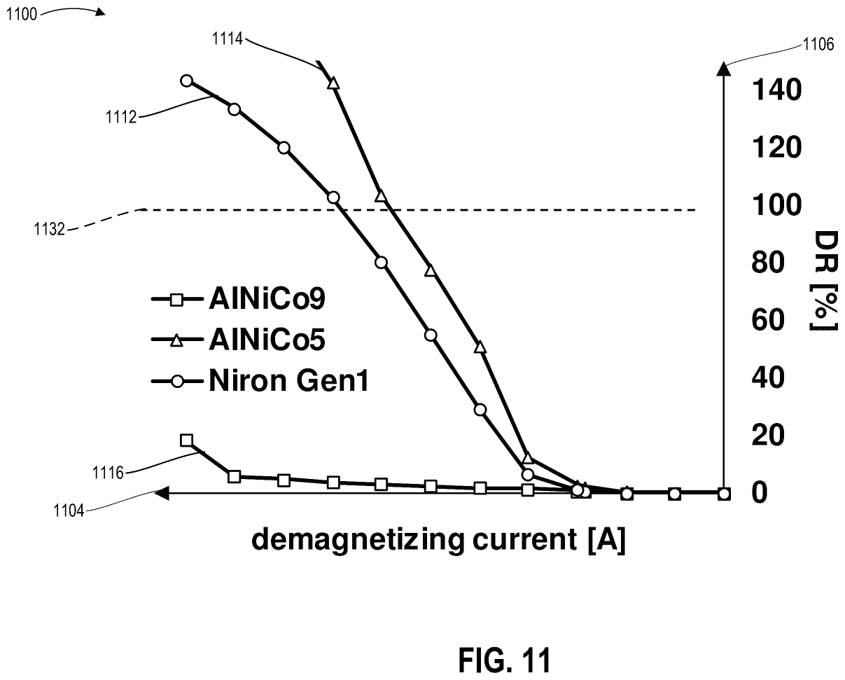

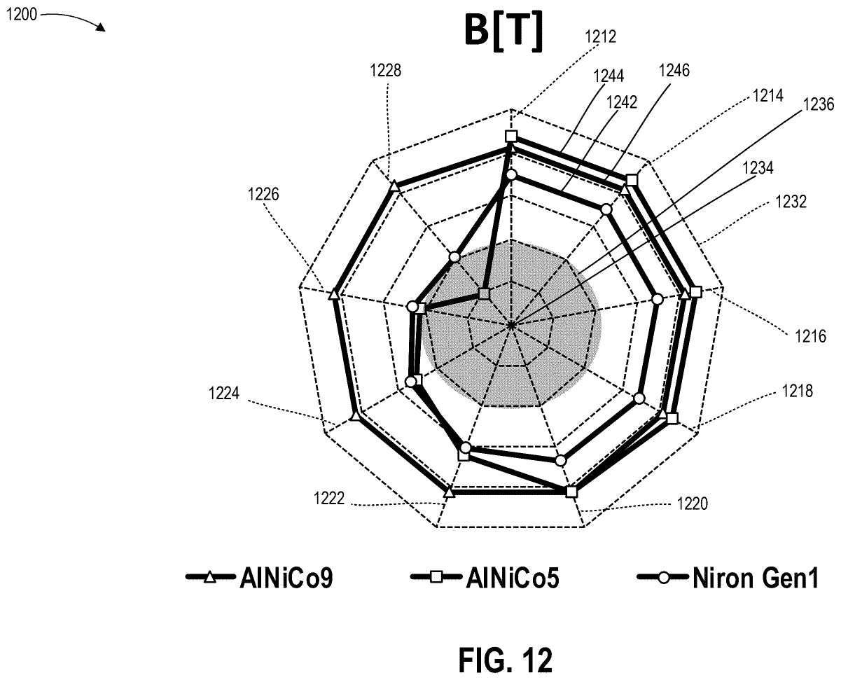

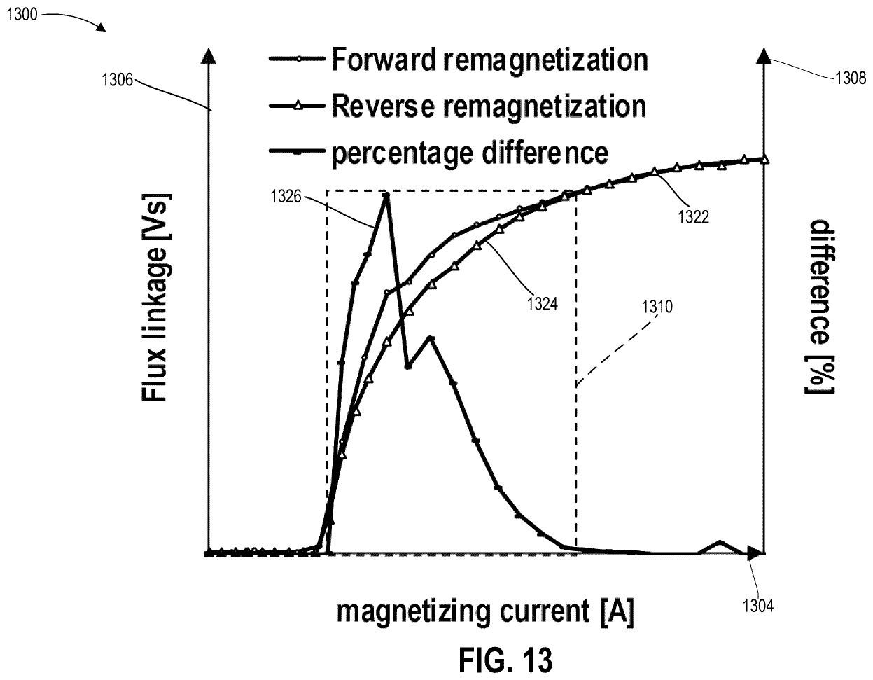

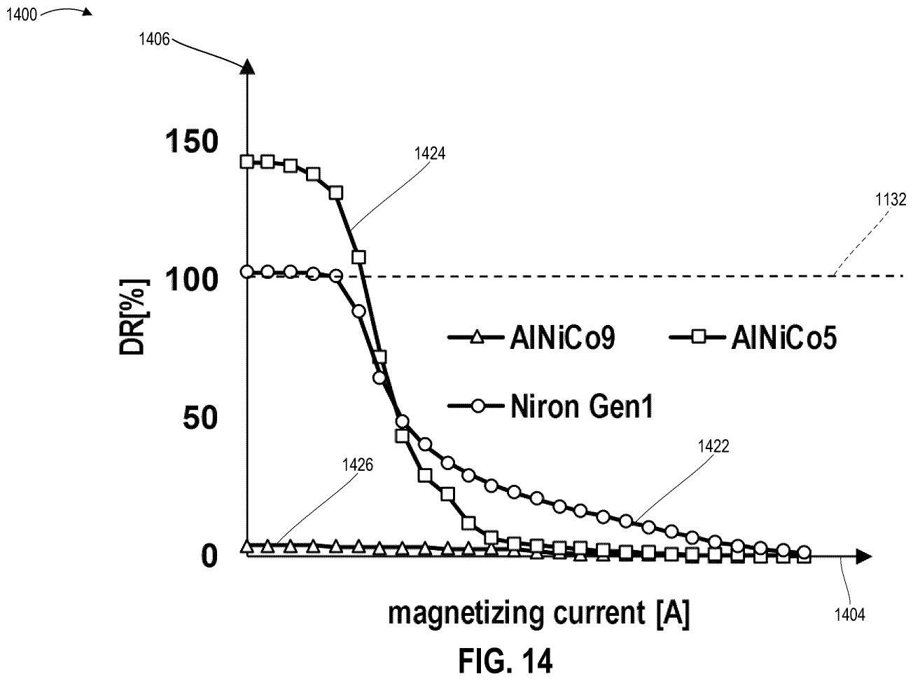

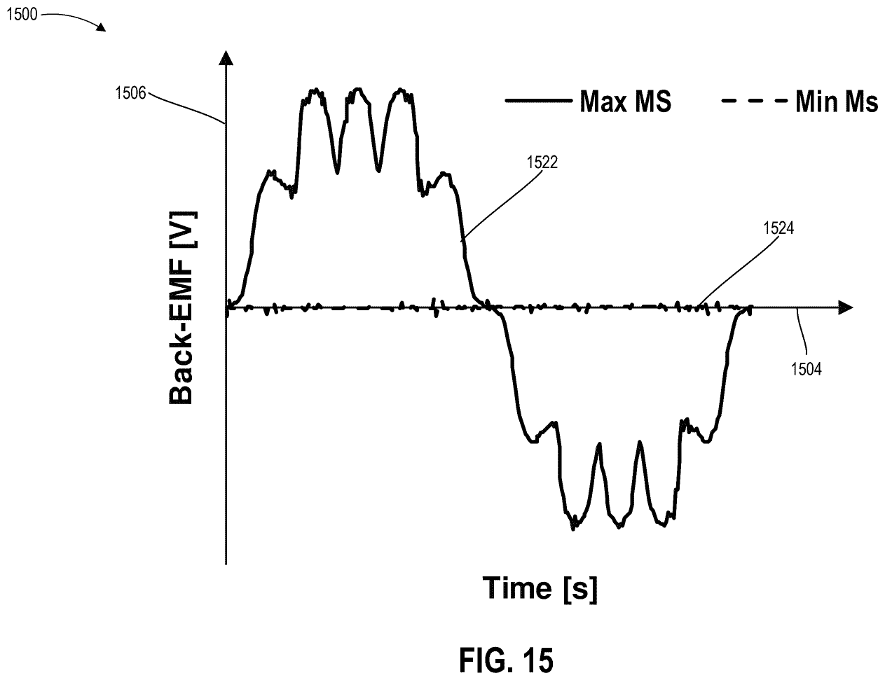

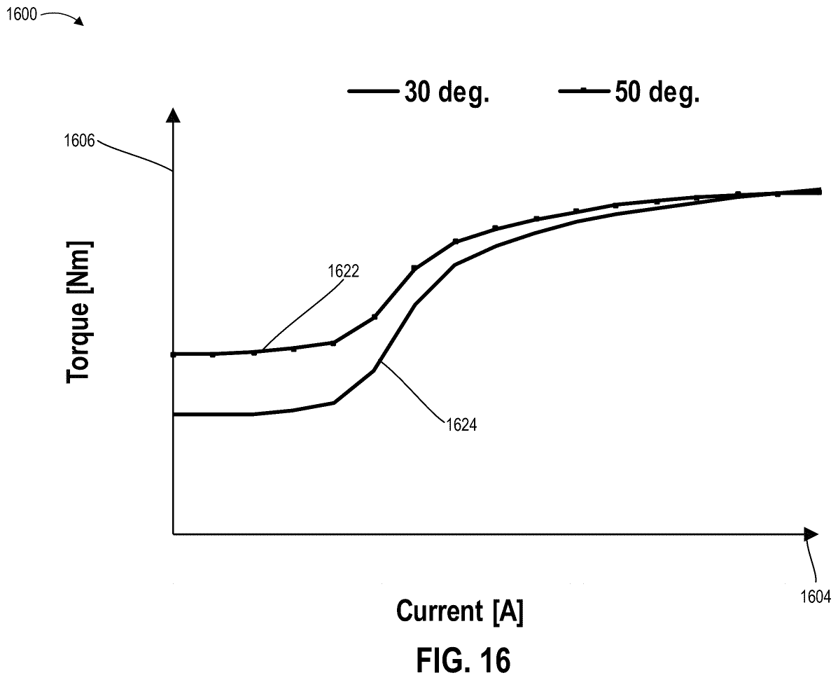

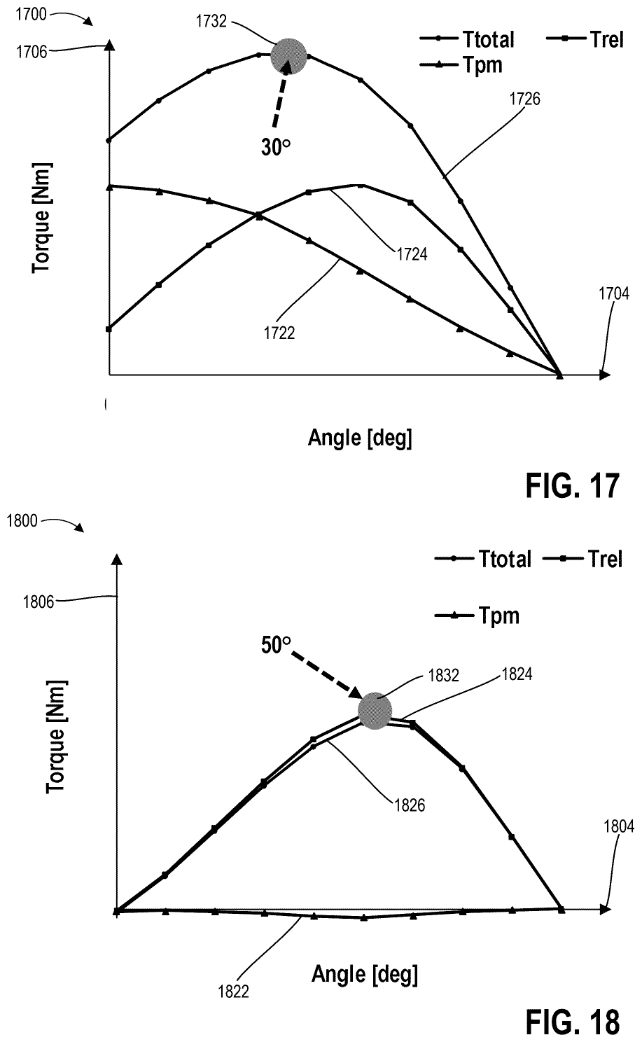

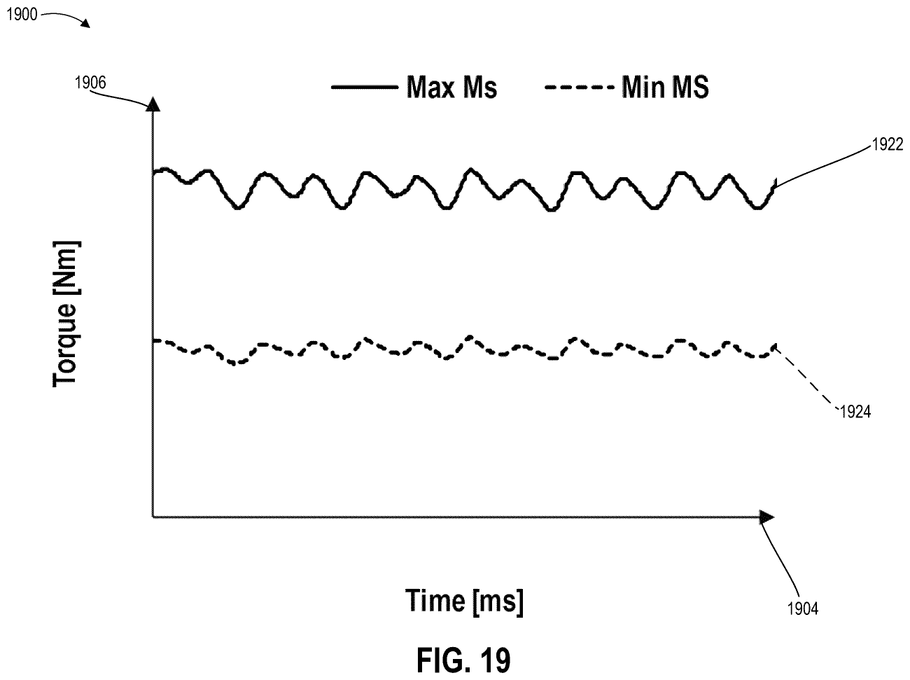

FIG. 9 shows a plurality of traces for a plurality of magnetic materials of permanent magnets housed by the assembly, the traces showing magnetic flux densities (B) at different magnetic field strengths (H). FIG. 10 shows a trace of a de-magnetization curve for the electric machine, where the trace shows magnetic flux at different de-magnetizing currents. FIG. 11 shows a plurality of traces of de-magnetization curves for the magnetic materials, where the traces show de-magnetization ratios at different de-magnetization currents. FIG. 12 shows a radar chart with a plurality of traces showing the change in B for the magnetic materials at different conditions. FIG. 13 shows a graph with a plurality of traces showing re-magnetization curves for the electric machine. FIG. 14 shows a graph with a plurality of traces showing re-magnetization curves for the magnetic materials, where the traces show de-magnetization ratios at different magnetization currents. FIG. 15 shows a graph of a plurality of traces of back-electromagnetic force (back-EMF) over time for magnetization states of the electric motor. FIG. 16 shows a graph of traces of torque relative to current for different current angles. FIG. 17 shows a graph of a plurality of traces of energy from torque at different current angles for different torques of the electric machine. FIG. 18 shows a graph of a plurality of traces of energy from torque at different current angles for different torques of the electric machine. FIG. 19 shows a graph of a plurality of traces that show energy from torque over time for different magnetization states.

FIG. 1 schematically illustrates an electric vehicle 100 with an electric drive system 102 that provides power to and is incorporated into an axle assembly 104 vehicle 100. The vehicle 100 may take a variety of forms in different examples, such as a light, medium, or heavy duty vehicle. Additionally, the electric drive system 102 may be adapted for use in front and/or rear axles, as well as steerable and non-steerable axles. To generate power, the electric drive system 102 may include an electric machine 106. In some examples, the electric machine 106 may be an electric motor-generator and may thus include conventional components such as a rotor, a stator, and the like housed within an electric machine housing 107 for generating mechanical power as well as electric power during a regenerative mode, in some cases. Further, in other examples, the vehicle 100 may include an additional motive power source, such as an internal combustion engine (ICE) (e.g., a spark and/or compression ignition engine), for providing power to another axle. As such, the electric drive system 102 may be utilized in an electric vehicle (EV), such as a hybrid electric vehicle (HEV) or a battery electric vehicle (BEV).

In some examples, the electric machine housing may be coupled (e.g., via bolts) to a housing of a gearbox. Further, the electric machine may provide mechanical power to a differential via the gearbox. From the differential 110, mechanical power may be transferred to drive wheels 112, 114 by way of axle shafts 116, 118, respectively, of the axle assembly 104. As such, the differential 110 may distribute torque, received from the electric machine 106 via the transmission 108, to the drive wheels 112, 114 of the axle shafts 116, 118, respectively, during certain operating conditions. In some examples, the differential 110 may be a locking differential, an electronically controlled limited slip differential, or a torque vectoring differential.

Alternatively, for another example, the movers and transmissions of the vehicle 100, such as the electric machine 106 and transmission 108 may output torque directly to a wheel of the vehicle 100, such as either of the wheels 112, 114, where rotary power from the electric machine 106 is prevented from transferring through a differential, such as differential 110. Such an arrangement of mover and transmission therein be referred to herein as wheel side movers and wheel side transmissions. A mover and a gear train may drivingly couple and output torque to the wheel side transmission, where rotary power may flow from the mover to the gear train and from the gear train to the wheel side transmission. For another example, the mover and the gear train may drivingly couple to one or more wheels of the wheels 112 114. The mover and the gear train may drive one or more wheels, where rotary power may flow from the mover to the gear train and from the gear train to the one or more wheels. For example, of a wheel side configuration of vehicle 100, the vehicle 100 may lack an axle assembly 104. For this example, the transmission 108 may be a wheel side transmission and rigidly couple to a wheel of the wheels 112, 114 via a shaft, such as a shaft of the axle shafts 116, 118. The transmission 108 may be housed via a transmission housing 109.

The transmission 108 may be at least a single-speed transmission, such as a single-speed gearbox, where the transmission 108 operates in one gear ratio. However, other transmission arrangements have been envisioned such as a multi-speed transmission that is designed to operate in multiple distinct gear ratios. For other examples, the transmission 108 may be a 2-speed transmission, a 3-speed transmission, a 4-speed transmission, a 5-speed transmission, a 6-speed transmission, a 7-speed transmission, a 8-speed transmission, a 9-speed transmission, a 10-speed transmission, an 11-speed transmission, a 12-speed transmission, a 13-speed transmission, a 14-speed transmission, a 15-speed transmission, a 16-speed transmission, a 17-speed transmission, a 18-speed transmission, a 19-speed transmission, a 20 speed transmission, or an n-speed transmission.

In an example, the electric machine 106, the transmission 108, and the differential 110 may be incorporated into the axle assembly 104, forming an electric axle (e-axle) in the vehicle 100. The e-axle, among other functions, for provides motive power to the drive wheels 112, 114 during operation. Specifically, in the e-axle embodiment, the electric machine and gearbox assembly may be coupled to and/or otherwise supported by an axle housing. In one particular example, the e-axle may be an electric beam axle where a solid piece of material (e.g., a beam, a shaft, and/or a housing) extends between the drive wheels. The e-axle may provide a compact arrangement for delivering power directly to the axle. In other examples, however, the electric machine 106 and the transmission 108 may be included in an electric transmission system in which the gearbox and/or electric motor are spaced away from the axle. For instance, in the electric transmission example, mechanical components such as a driveshaft, joints (e.g., universal joints), and the like may provide a rotational connection between the electric transmission and the drive axle.

The electric drive system 102 may further include a heat exchange circuit 130. The heat exchange circuit 130 may circulate a heat exchange fluid that may uptake and eject thermal energy. For example, the heat exchange circuit 130 may be a coolant/cooling circuit that circulates coolant (e.g., water and/or glycol) through a jacket 131. The jacket 131 may therein be a coolant jacket that cools the electric machine via the heat exchange fluid of the heat exchange circuit 130. The electric machine housing 107 may comprise or house the jacket 131. The heat exchange circuit 130 may include a coolant inlet 138 and a coolant outlet 132 positioned on (or in) the electric machine housing 107. The heat exchange circuit 130 may further include a filter 133 and a pump 134 that circulates coolant from the coolant outlet 132 to the coolant inlet 138 via a coolant delivery line 136. From the coolant inlet 138, the coolant travels into the jacket 131 formed in the electric machine housing 107 which removes heat from components of the electric machine 106. In some examples, the heat exchange circuit 130 may further include a heat exchanger (e.g., radiator) which removes heat from the coolant that exits the electric machine housing 107 by way of the coolant outlet 132.

The heat exchange circuit 130 may be a water cooled cooling circuit, where water is used as a coolant, and therein the jacket 131 may be a water jacket. However, it is to be appreciated that the heat exchange circuit 130 may use other forms of coolant to cool the electric machine 106, such as oil. The heat exchange circuit 130 may also be a lubrication circuit, where the heat exchange circuit 130 transports lubricant to lubricate internal components of the electric machine, such as windings and bearings. The lubricant may be oil.

The vehicle 100 may also include a control system 140 with a controller 141. The controller 141 may include a processor 142 and a memory 144. The memory may be non-transitory memory and may hold instructions stored therein that when executed by the processor cause the controller 141 to perform various methods, control techniques, and the like described herein. The processor 142 may include a microprocessor unit and/or other types of circuits. The memory 144 may include known data storage mediums such as random access memory, read only memory, keep alive memory, combinations thereof, and the like. The controller 141 may receive various signals from sensors 146 positioned in different locations in the vehicle 100 and electric drive system 102. The controller 141 may also send control signals to various actuators 148 coupled at different locations in the vehicle 100 and electric drive system 102. For instance, the controller 141 may send command signals the pump 134 and, in response, the actuator(s) in the pump(s) may be adjusted to alter the flowrate of the oil and/or coolant delivered therefrom. The control system 140 and the electric drive system 102 may thus be communicatively coupled, as is indicated by the dotted line 150. In other examples, the controller may send control signals to the electric machine 106 and, responsive to receiving the command signals, the electric machine may be adjusted to alter a rotor speed, such as to increase or decrease the rotational speed of the rotor. The other controllable components in the system may be operated in a similar manner with regard to sensor signals and actuator adjustment.

A set of reference axes 201 are provided for comparison between views shown in FIGS. 2-8C and FIGS. 17-18, for reference. The reference axes 201 indicate a y-axis, an x-axis, and a z-axis. The z-axis may be a vertical axis (e.g., parallel to a gravitational axis), the x-axis may be a lateral axis (e.g., horizontal axis), and/or the y-axis may be a longitudinal axis, in one example. However, the axes may have other orientations, in other examples. The x-y plane may be parallel with a plane that the electric machine 106 may rest upon. When referencing direction, positive may refer to in the direction of the arrow of the y-axis, x-axis, and z-axis and negative may refer to in the opposite direction of the arrow of the y-axis, x-axis, and z-axis. A filled circle may represent an arrow and axis facing toward, or positive to, a view. An unfilled circle may represent an arrow and an axis facing away, or negative to, a view.

An axis 299 of the electric machine 106 is further provided for reference in FIGS. 2-8C and FIGS. 17-18. The axis 299 may be a central axis and a rotational axis for the electric machine 106. A cutting plane 2-2 for the cross-sectional view depicted in FIG. 3 is provided in FIG. 2. The cutting plane 2-2 extends through an axis 299 of the electric machine 106.

Features described as axial may be approximately parallel with an axis referenced unless otherwise specified. Features described as counter-axial may be approximately perpendicular to the axis referenced unless otherwise specified. Features described as radial may circumferentially surround or extend outward from an axis, such as the axis referenced, or a component or feature described prior as being radial to a referenced axis, unless otherwise specified. Unless otherwise specified, the axis referenced may be axis 299.

FIG. 2 shows an illustration of the electric machine 106. The electric machine 106 may be designed as an electric motor, a generator, or an electric motor-generator and may be included in a system 202 which may take a variety forms. For instance, the electric machine 106 may be incorporated into an electric drive system of an electric vehicle (EV), in one example, such as the vehicle 100 of FIG. 1. As such, the electric machine 106 may be a traction motor and the electric drive may further include a transmission (e.g., gearbox), for instance, such as the electric drive system 102 and the transmission 108 of FIG. 1. In the EV example, the EV may be an all-electric vehicle (e.g., a battery electric vehicle (BEV)), in one example, or a hybrid electric vehicle (HEV) with an internal combustion engine, in another example. However, the electric machine 106 may be used in other suitable systems (e.g., stationary systems), in other examples, such as in industrial machines, agricultural systems, mining systems, and the like.

The electric machine 106 includes a rotor 204 that electromagnetically interacts with a stator 206 to drive rotation of a rotor shaft 208 that is included by or rigidly coupled to the rotor 204. The electric machine 106 in the illustrated example includes the housing 107 with an electrical interface 212 for the stator 206. The electrical interface 212 may be a multi-phase electrical interface with multiple electrical connectors 214. The electrical interface 212 may be a three-phase interface, in the illustrated example. However, it will be understood that the configuration of the electrical interface 212 may non-limiting. For example the electrical interface 212 be another multiphase interface, such as a six phase interface or a nine phase interface, in other examples. More generally, the electric machine 106 may be a multi-phase alternating current (AC) machine. More specifically, the electric machine may be a Variable Flux Machine (VMF), such as a memory machine (MM). MMs may include memory motors, memory generators, and memory motor/generators.

As illustrated in FIG. 2, the electric machine 106 may be electrically coupled to an inverter 216. The inverter 216 is designed to covert direct current (DC) power to alternating current (AC) power and vice versa. As such, the electric machine 106 may be an AC electric machine such as an AC electric motor, as indicated above. However, in other examples, the electric machine 106 may be a DC electric motor (as previously indicated) and the inverter 216 may therefore be omitted from the system 202. The inverter 216 may receive electric energy from one or more energy storage device(s) 218 (e.g., traction batteries, capacitors, combinations thereof, and the like). Arrows 220 signify the electric energy transfer between the electric machine 106, the inverter 216, and the energy storage device(s) 218 that may occur during different modes of system operation.

The system 202 may additionally include a control sub-system 280 with a controller 282. The controller 282 includes a processor 284 and memory 286. The memory 286 may hold instructions stored therein that when executed by the processor 284 cause the controller 282 to perform the various methods, control techniques, and the like, described herein. The processor 284 may include a microprocessor unit and/or other types of circuits. The memory 286 may include known data storage mediums such as random access memory, read-only memory, keep alive memory, combinations thereof, and the like.

The controller 282 may receive various signals from sensors 288 positioned in different locations in the system 202. The sensors 288 may include an electric machine speed sensor, energy storage device temperature sensor(s), an energy storage device state of charge sensor(s), an inverter power sensor, and the like. The controller 282 may also send control signals to various actuators 290 coupled at different locations in the system 202. For instance, the controller may send signals to the inverter 216 to adjust the rotational speed of the electric machine 106. In another example, the controller 282 may send a command signal to the electric machine 106 and/or the inverter 216 and in response motor speed may be adjusted. The other controllable components in the system 202 may function in a similar manner with regard to command signals and actuator adjustment.

The system 202 may also include one or more input device(s) 292 (e.g., an accelerator pedal, a brake pedal, a console instrument panel, a touch interface, a touch panel, a keyboard, combinations thereof, and the like). The input device(s) 292, responsive to user input, may generate a motor speed adjustment request.

The system 202 may be the system 140 of FIG. 1. The controller 282 may therein be the controller 141 of FIG. 1, and the processor 284 and the memory 286 may therein respectfully be the processor 142 and memory 144 of FIG. 1. Further the sensors 146 and the various actuators 148 of FIG. 1 may be or include the sensors 288 and various actuators 290.

An example schematic 300 of the electric machine 106 is depicted in FIG. 3. The schematic 300 is a simplified schematic illustration of a cross-section of the electric machine 106. The schematic 300 may be an example schematic representation of a sectional perspective taken of the electric machine 106 taken on the cutting plane 2-2. It will be noted that the cross-section depicts a portion of the electric machine 106. It will be understood that the electric machine 106 includes various additional components that are omitted from FIG. 3 for clarity. The electric machine 106 includes a stator 206, including a stator core 302 with a plurality of end windings 304 protruding axially (e.g., along the central axis of rotation: axis 299) from either end of the stator core 302.

The stator core 302 may circumferentially surround a rotor 204 of the electric machine 106 and may be spaced away from the rotor 204 via an air gap 308 (e.g., a radial air gap). The air gap 308 may be a distance represented by a plurality of arrows 309. The rotor 204 has a rotor core 310, which may include permanent magnets to generate magnetic flux fields and allow the rotor 204 to rotate at synchronous speeds in response to a supplied current. The rotor core 310 is rigidly coupled to a shaft 208 of the rotor 204, such that the rotor core 310 and the shaft 208 rotate as a single unit. In one example, a length of the shaft 208, as defined along the central axis of rotation (e.g., axis 299), may be greater than a length of the rotor core 310, which may be similar to a length of the stator core 302. The rotor 204 may be formed of different materials depending on an application and a rotor sub-section. For example, the shaft 208 may be formed of steel or a similar metal able to transmit torque and having a desired stiffness. The rotor core 310 of the rotor 204 may comprises of a high permeability steel with embedded permanent magnets, as an example. Likewise, the stator core 302 may comprise a high permeability steel.

The stator 206 and the rotor 204 may be enclosed within the housing 107 which may include a jacket for heat exchange fluid, such as the jacket 131 of FIG. 1. The housing 107 includes a sleeve portion 316, a first end plate 318, and a second end plate 320, the sleeve portion 316 and the end plates described further below. The housing 107 may entirely surround the stator core 302 and may be formed of a rigid, thermally conductive material, such as aluminum, that is lightweight and low cost as well as mechanically strong and durable. By positioning the housing 107 in direct contact with the stator core 302, heat generated at the stator core 302 may be conducted away from the stator core 302 into the housing 107, as indicated by arrows 307. In some instances, the housing 107 may be air-cooled, transferring heat from the housing 107 to air flowing over the electric machine 106. In other examples, the housing 107 may be liquid-cooled, allowing heat to be exchanged at a coolant flowing through one or more coolant channels of the housing 107.

For example, the sleeve portion 316 of the housing 107 may circumferentially surround the stator core 302 along a direction parallel with the central axis of rotation (e.g., axis 299). When the housing 107 is configured to be liquid-cooled, the sleeve portion 316 of the housing 107 may include at least one coolant channel fluidically coupled to the heat exchange circuit 130, for example, a vehicle, as indicated by arrows 305. Cooling of the stator 206 may therefore not demand a separate additional cooling system, such as an oil-based cooling system, that adds complexity and cost to implementation of the electric motor. The housing 107 may also include the first end plate 318 and the second end plate 320, the end plates arranged perpendicular to the central axis of rotation (e.g., axis 299) and coupled to ends of the sleeve portion 316 of the housing 107. The end plates may be formed of a same or different material as the housing 107. In some examples, the end plates may be formed of aluminum to provide high thermal conductivity while maintaining a low weight of the end plates. The first end plate 318 has a central opening 322 (e.g., an opening centered about the axis 299) to accommodate an arrangement of components coupled to the rotor 204, such as bearings, seals, etc. (not shown in FIG. 3).

Inner faces of the first and second end plates 318, 320 may receive the end windings 304 at respective ends of the electric machine 106. However, the end windings 304 may be spaced away from the inner faces of the end plates due to a slotted configuration of the inner faces, as described further below with reference to FIG. 4. For example, slots or indentations in the inner faces of the end plates may aligned with the end windings 304 such that tips of the end windings 304 may be inserted into the slots without contacting the end windings 304, and therefore without exerting any mechanical forces on the end windings 304. Spaces between the end plates and the end windings 304 within the slots may be filled with a flexible, thermally conductive potting material to provide mechanical support to the end windings 304 while enabling conductive transfer of heat from the end windings 304 to the end plates.

The first and second end plates 318, 320 may, in one example, be coupled to the sleeve portion 316 of the housing 107, such that the first and second end plates 318, 320 and the housing 107 form a single, continuous unit. Alternatively, the end plates may be separate units from the sleeve portion 316 and may be attached to the sleeve portion 316 by welding, fasteners, etc. The end plates may allow heat to be dissipated from the end windings 304 by conducting heat from the end windings 304 to the sleeve portion 316 of the housing 107, as indicated by arrows 307. In comparison to heat dissipation through the rotor core 310 to the housing 107, heat transfer across the end plates provides additional thermal transfer paths for heat generated at the end windings 304. Heat management of the end windings may be faster and more efficient, due to a high thermal conductivity of the end plate material.

In some examples, the end plates each include at least one coolant channel fluidically coupled to the at least one coolant channel of the sleeve portion 316, as indicated by arrows 305, enabling coolant from the heat exchange circuit 130 to be circulated to the end plates, thereby increasing a cooling capacity of the end plates. In yet other examples, only one of the end plates may have the at least one coolant channel and the other end plate may not include coolant channels. In particular, the end plate coupled to the welded set of end windings may be configured with at least one coolant channel due to a tendency for hot spots to be generated at the welded set of end windings. The hot spots may form as a result of a greater length of the welded set of end windings compared to the crown set of end windings, when the conductive windings are the hairpin windings.

By configuring the housing 107 with the first and second end plates 318, 320, each configured to receive the end windings 304 of the stator 206, an additional heat flux path may be provided for the stator 206. For example, without the configuration of the end plates as described herein, heat generated at the end windings 304 may instead be conducted to the stator core 302 at the ends of the stator core 302, and through the stator core 302 to the sleeve portion 316 of the housing 107. This may increase a cooling burden of the sleeve portion 316, thereby decreasing a cooling efficiency of the housing 107. With the end plates coupled to the sleeve portion 316 of the housing 107, the heat from the end windings 304 may instead be conducted away from the stator core 302, increasing overall heat dissipation from the stator 206.

In some instances, the rotor 204 may also be configured to flow the coolant therethrough when the housing 107 is liquid-cooled. For example, as shown in FIG. 3, the shaft 208 of the rotor 204 may include a plurality of first channels 324 extending along a portion of the length of the rotor core 310. The first channels 324 may be disposed in a portion of the rotor 204 that remains stationary and does not rotate. Additionally, the shaft 208 may include a plurality of second channels 326 extending along a portion of the length of the shaft 208. The first and second channels 324, 326 may be fluid channels, and more specifically heat exchange channels such as cooling channels. A heat exchange fluid, such as coolant, may flow through the first and second channels 324, 326 to uptake thermal energy from the rotor 204 and the shaft 208.

The first channels 324 and the second channels 326 may be coupled to the at least one coolant channel of one of the end plates such that the coolant is delivered to the first channels 324 and/or second channels 326 from the end plate. In this way, coolant may be circulated from the heat exchange circuit 130 of the vehicle, to the sleeve portion 316 of the housing 107, into one or more of the first and second end plates 318, 320, and into the shaft 208 of the rotor 204 before flowing back to a heat sink of the heat exchange circuit 130, such as a heat exchanger. Heat extraction via coolant flow at the end plates and the rotor shaft allows temperatures of the end windings, the rotor, as well as bearings and seals coupled to the rotor, to be maintained below a temperature threshold, such as 100° C., as an example.

In order to maximize cooling of the end windings by the end plates, it may be desirable to position the end windings as close as possible to the end plates while providing sufficient clearance to accommodate thermal expansion of the end windings. This may be achieved by configuring inner faces of the end plates, e.g., faces of the end plates facing the end windings, with slots or indentations for receiving the end windings. For example, tips of the welded set of end windings may be at least partially recessed into the indentations, thereby decreasing an amount of extra length added to the electric motor due to a capping of the stator by the end plates at either end.

Turning to FIG. 4 shows a view 400 of an assembly 402 including the stator 206, rotor 204, and a plurality of magnets 414 centered radially around the axis 299. The view 400 is an exploded view of the assembly 402. The stator 206 and the stator core 302 may comprise a plurality of first laminations 410. The rotor 204 the rotor core 310 may comprise a plurality of second laminations 412. The first laminations 410 and the second laminations 412 may be non-limiting representations with there being less or more of the first laminations 410 and/or second laminations 412 than shown in FIG. 4. Likewise, the first laminations 410 and/or second laminations 412 may be of different dimensions than are shown in FIG. 4. Further, the laminations 410, 412 may be shown in a schematic form relative to the other components and features of the assembly 402. Alternatively, it is to be appreciated that for another example the stator 206 and rotor 204 may lack laminations. For example, the stator core 302 may be a singular and unitary structure lacking laminations and/or segmentation. Likewise, for this or another example, the rotor core 310 be singular and unitary structures, lacking laminations and/or segmentation.

A gap of air, referred to herein as an air gap. may be sandwiched between the stator and the rotor. The air gap may be represented via arrows 409, and the air gap of FIG. 4 may be the air gap 308 and distance represented by arrows 309 described in FIG. 3. The air gap represented via arrows 409 is approximately to scale. More specifically, the air gap represented via arrows 409 may be arranged approximately radially between the stator 206 and the rotor 204.

The stator 206 and rotor 204, and more specifically the stator core 302 and the rotor core 310, may be comprise a type of high permeability steel, such as steel alloy comprising iron and nickel. The first laminations 410 of the stator and second laminations 412 may therein comprise high permeability steel. The stator 206 and the stator core 302 are hollow and may comprise a first hole 406. And the rotor 204 and the rotor core 310 may be hollow and may comprise a second hole 408. The first and second holes 406, 408 may be through holes. The rotor 204 may be housed via the rotor core 310 via the first hole 406, where the rotor 204 may be position concentric to the first hole 406. A shaft, such as the shaft 208 of FIGS. 2-3, may be housed by and rigidly coupled to the rotor core 310 via the second hole 408. The first hole 406 and the second hole 408 may be centered radially around the axis 299.

The magnets 414 are permanent magnets, and more specifically may be permanent magnets free of rare-earth materials. Said in another way, the magnets 414 may be free of (e.g., do not include) rare-earth permanent magnets. The rotor 204 may include and house two magnet layers, where the magnets 414 comprise the magnets of two magnetic layers. A first magnetic layer is responsible for torque production which can be made of the strongest magnet (highest coercivity) in the magnetic circuit. Another object of the first magnetic layer is to maximize the utilization of the reluctance torque. The second magnetic layer is responsible for facilitating the flux regulation. In the present embodiment, the top most layer (e.g., radially outward most layer) of magnets is the first magnetic layer, and includes magnets made of Iron-Nitride (FeN) material that are higher coercivity and relatively lower residual flux density compared to other magnets of the rotor 204. The HC magnets such as the first and second magnets 416a, 416b arranged in a V-shape, may therein comprise FeN. The magnets of the first magnetic layer may therein be referred to as HC magnets.

The magnets of the second magnetic layer may be made of a material of lower coercivity, such as different grades of alnico alloys (AlNiCo). The different grades of AlNICo materials have different magnetic properties including coercivity. A first grade of AlNiCo comprising magnets of may have a greater or lesser coercivity compared to a second grade of AlNiCo for other magnets.

The magnets of the second magnetic layer may receive current and magnetic flux via magnetic flux paths through the first magnetic layer for reaching the air gap. Therefore, under loading conditions, a plurality of magnets of the first magnetic layer guards another plurality of magnets of the second magnetic layer from de-magnetization.

For example, the magnets 414 include a first set of magnets enclosed by a first ellipse 415 of dashed lines. The first set of magnets may be arranged to form the first magnetic layer. A second set of magnets may be enclosed by a second ellipse 417 of dashed lines. The second set of magnets may be arranged to form the second magnetic layer. The first set of magnets may be arranged radially inward of the second set of magnets relative to the axis 299. There is a plurality of the first sets of magnets enclosed by the first ellipse 415 and a plurality of the second sets of magnets enclosed by the second ellipse 417. Each of the second sets of magnets enclosed by the second ellipse 417 includes at least a pair of magnets, where each magnet of the pair is a different grade of AlNiCo having a different coercivity.

Further the magnets of the second magnetic layer may be divided into a plurality of top magnets and a plurality of bottom magnets, where top and bottom are relative radially to the axis 299. The top and bottom magnets of the second magnetic layer may be electrically coupled and magnetically coupled in a parallel arrangement to form a magnetic circuit (MC). Each of the top parallel magnets is featured with a lower coercivity compared to each of the bottom parallel magnets. The difference in coercivity between the top and bottom parallel magnets facilitates controlling the operating point of each of the top parallel magnets throughout de-magnetization or re-magnetization. Said in another way, the top parallel magnets have the lowest coercivity of the LC magnets.

Each of the first sets of magnets represented by the first ellipse 415 may include a plurality of first magnets 416a and a plurality of second magnets 416b. The first magnets 416a and second magnets 416b may be the same type of magnet, comprised of the same material and of the same dimensions. The first magnets 416a and the second magnets 416b may be the permanent magnets with the highest coercivity of the rotor 204, (e.g., are the HC magnets of the rotor 204). For example, each of the first magnets 416a and the second magnets 416b may comprise Iron-Nitride (FeN). However, it is to be appreciated that the composition of the first magnets 416a and the second magnets 416b may be non-limiting. For example, another configuration of the first and second magnets 416a, 416b may be a different grade of FeN, such as a higher grade with less impurities. For another example, another configuration of the first and second magnets 416a, 416b may be varying grades of the alnico (AlNiCo) alloy magnets with a higher coercivity compared to the other magnets of magnets 414.

Each of the first magnets 416a may be positioned to mirror the second magnets 416b, such as to be arranged in a V-shape. The first magnets 416a and second magnets 416b may be received and integrated into the stator via at least a plurality of slots, where at least a slot may house a pair of the first magnets 416a and the second magnets 416b such that the pair is arranged in the V-shape. However, it is to be appreciated that there may be a plurality of slots, where specific slots receive the first magnets 416a and other specific slots may receive the second magnets 416b.

Each second set includes a pair of magnets. The second sets of magnets represented by the second ellipse 417 may include a plurality of third magnets 418 and a plurality of fourth magnets 420. The third magnets 418 may abut and contact the fourth magnets 420. The fourth magnets 420 may be radially inward from the third magnets 418 relative to the axis 299. Said in another way, the third magnets 418 may be positioned at radially outward direction from and arranged radially on top of the fourth magnets 420. The third magnets 418 and the fourth magnets 420 may comprise different grades of AlNiCo alloy, where the different grades of AlNiCo have different compound (e.g., molecular) level quantities of aluminum (Al), nickel (Ni), or cobalt (Co). For an example, the different grades of AlNiCo alloy have different amounts of Co. For this example, the third magnets may be made of or comprise in part AlNiCo₅, and the fourth magnets be made of or comprise in part AlNiCo₉. The third magnets 418 and fourth magnets 420 may be weaker (e.g., lower in coercivity) compared to the first and second magnets 416a, 416b. The third magnets 418 and fourth magnets 420 may therein be the LC magnets of the rotor 204. Further, the third magnets 418 may be lower in coercivity compared to the fourth magnets 420. Said in another way, the fourth magnets 420 may be higher in coercivity compared to the third magnets 418. The third magnets 418 may therein be the weaker of the LC magnets.

Each pair of magnets of each second set of magnets enclosed by the second ellipse 417 may be magnetically coupled in a parallel configuration to form an MC. More specifically, a third magnet of the third magnets 418 and a fourth magnet of the fourth magnets 420 may be magnetically coupled to form the MC, the MC being a parallel MC.

The stator core 302 may include a plurality of teeth 422 extending radially inward from the stator core. Between pairs of the teeth 422 is a cavity of a plurality of cavities 424. A plurality of stator windings 426 may be integrated into the stator 206, and more specifically, the stator core 302. For example, the stator windings 426 may be rigidly coupled to the stator 206 and stator core 302 via being housed in the cavities 424 and between the teeth 422. The stator windings 426 may be connected to the end windings 304, such as to electrically couple and thermally couple. The stator windings 426 may provide the electromagnetic forces and torque to affect the permanent magnets 414 and rotate the rotor 204.

The rotor core 310 and the second hole 408 may form a surface 432. The surface may curve radial around the axis 299. The surface 432 may be cylindrical in shape. A shaft, such as the shaft 208 of FIGS. 2-3, may abut and rigidly couple to the rotor core 310 via surface 432.

The rotor core 310 may have a plurality of first holes 440, a plurality of second holes 442, and a plurality of third holes 444. The first holes 440, the second holes 442, and the third holes 444 may extend in an axial direction, such as with respect to the axis 299, through the second laminations 412. The first holes 440, the second holes 442, and the third holes 444 may extend from a first end to a second end of the rotor 204, where the first end is opposite the second end. Said in another way, the first holes 440, the second holes 442, and the third holes 444 may extend a length 472 of the rotor 204 and the rotor core 310. The first holes 440, the second holes 442, and the third holes 444 may be positioned radially around the second hole 408 with respect to axis 299. The first holes 440 and the second holes 442 may be approximately the same dimensions, each of the first holes 440 may mirror a hole of the second holes 442, and the first holes 440 and the second holes 442 may be grouped in pairs. For an example of, the first holes 440, the second holes 442, and the third holes 444 may house or form fluid passage. The fluid passages may be fluid channels, and more specifically heat exchange channels, such as the first channels 324 of FIG. 3. The heat exchange channels of the rotor core 310 may be used to remove or add thermal energy to the rotor 204 and components integrated therein, such as the magnets 414. The fluid passages housed or formed by the first holes 440, the second holes 442, and the third holes 444 may transport coolant or another heat exchange fluid and be fluidically coupled to components of a be part of or fluidly coupled to a cooling system, such as the heat exchange circuit 130. The fluid passages housed or formed by the first holes 440, the second holes 442, and the third holes 444 may therein be fluidically coupled to and cooled via a jacket, such as the jacket 131 of FIG. 1. The fluid passages housed or formed by the first holes 440, second holes 442, and the third holes 444 may therein cool the rotor 204.

The rotor 204 includes a plurality of first slots 462, a plurality of second slots 464, a plurality of third slots 466, and a plurality of fourth slots 468. The first slots 462, the second slots 464, the third slots 466, and the fourth slots 468 may be arranged radially about the second hole 408 and may extend may extend the length 472 of the rotor 204 and the rotor core 310. The third slots 466 and the fourth slots 468 may also extend outward in a radial direction with respect to axis 299, and therein each of the third slots 466 and fourth slots 468 may be referred to as a radial slot. The first and second slots 462, 464 may be radially further from the axis 299 than the third slots 466. Each of the fourth slots 468 may be radially further from the axis 299 than the third slots 466. Said in another way, each fourth slot the fourth slots 468 may be a top slot relative to a third slot of the third slots 466, and the fourth slots 468 are radially outward from the third slots 466 with respect to the second hole 408.

The first and second slots 462, 464 may be arranged into sets, such as pairs. Each of the first slots 462 may be separated at an angle 470 from a second slot of the second slots 464, where the first slot of the first slots 462 and the second slot of the second slots 464 are of the same pair. The angle 470 is such that the first and second slots 462, 464 are positioned to form a V like shape. Said in another way, each pair of the first slots 462 and the second slots 464 are arranged in a V-shape to extend through the material of the rotor core 310. The first slots 462 and the second slots 464 may be approximately the same dimensions, and each of the first slots 462 may be arranged to mirror a second slot of the second slots 464. More specifically, each first slot may mirror a second slot belonging to a pair of first and second slots 462, 464. Each of the first slots 462 and each of second slots 464 may be separated via an internal rib 465 therebetween. However, it should be appreciated the separation of the first and second slots 462, 464 via a structure may be non-limiting. For another example of another configuration of the rotor 204, each of the first slots 462 and each of the second slots 464 may lack a structure, such as the internal rib 465. For this example, the each of the first slots 462 and second slots 464 may therein be a singular slot volumetrically continuous.

The third and fourth slots 466, 468 may be arranged into sets, such as pairs. Each fourth slot of a set of third and fourth slots 466, 468, may be arranged outward from and top from the third slot of the set. The third slots 466 may be volumetrically connected with the fourth slots 468, where each of the third slots 466 may be volumetrically connected with a fourth slot of the fourth slots 468 of the same set, such as via a passage or another volume sandwiched between the third slot and the fourth slot of the set.

The first magnets 416a and the second magnets 416b may be integrated into the rotor 204 and the rotor core 310 via the first and second slots 462, 464, respectfully. More specifically, the first slots 462 and the second slots 464 may each house and partially enclose the first magnets 416a and the second magnets 416b, respectfully. The third magnets 418 and the fourth magnets 420 may be integrated into the rotor 204 and the rotor core 310 via the third slots 466. More specifically, the third slots 466 may each house and partially enclose a third magnet and a fourth magnet of the third magnets 418 and fourth magnets 420, respectively.

The stator 206 and stator core 302 may be a first diameter 482 and a second diameter 484. The first diameter 482 is an outer diameter and the second diameter 484 is an inner diameter of the stator 206 and stator core 302. The second diameter 484 may be the diameter of the first hole 406. The rotor 204 and rotor core 310 may be a third diameter 486 and a fourth diameter, where the third diameter 486 is an outer diameter and the fourth diameter 488 is an inner diameter of the rotor 204 and rotor core 310. The fourth diameter 488 may be the diameter of the first hole 406. The second diameter 484 is greater than the third diameter 486, such that the rotor 204 may be housed by the first hole 406.

Turning FIG. 5 it shows a view 500, of the assembly 402, where the magnets 414 of FIG. 4 are integrated into the rotor 204. The view 500 is a cross-sectional view of the rotor 204 and stator 206, where the stator 206 houses the rotor 204 via the first hole 406. The view 500 is taken on a view plane normal to the axis 299 and the y-axis of the reference axes 201.

When housing magnets, the first slots 462, the second slots 464, the third slots 466, and the fourth slots 468 may form magnetic poles. For example, the rotor 204 may include a first pole enclosed and represented by a third ellipse 552, and a second pole enclosed and represented by a fourth ellipse 554. The third ellipse 552 and the fourth ellipse 554 comprise a plurality of curved and dashed lines. For one example, each pole may include at least a first magnet of the first magnets 416a, a second magnet of the second magnets 416b, a third magnet of the third magnets 418, and a fourth magnet of the fourth magnets 420.

The poles and permanent magnets of the rotor 204 may receive magnetic flux from electromagnetic forces from magnetic current running through the end windings 304 and the stator windings 426 of FIG. 4. Pulses of magnetic current and magnetic flux between the windings 304, 426 and poles of the rotor 204 may place magnetic forces on the rotor 204 from the windings 304, 426, such as torque, that may rotate the rotor 204. More specifically, torque to rotate the rotor 204 may include reluctance torque from the pulses and changing polarity of the windings 304, 426 driving the permanent magnet poles of the rotor 204 to align with the positive or negative charged magnetic fields of the windings 304, 426, and therein driving the rotor 204 rotate. Likewise, torque may include magnetic torque from permanent magnets of the rotor 204 and flux fields thereof, and the magnetic torque drive the rotor 204 to rotate. When driven to rotate, the rotor 204 may spin around the axis 299. The flux paths to drive the rotor 204 may extend from the windings 304, 426 through the material of the stator core 302, across the air flux gap represented by arrows 409, into the material of the rotor core 310, and into the magnets of magnetic poles. Examples of flux paths may be shown via the modes I-III shown in FIGS. 8A-8C.

Turning to FIG. 6, it shows a view 600 of the rotor 204, where the where the magnets 414 of FIG. 4 are integrated into the rotor 204. The view 600 is a cross-sectional view of the rotor 204. The view 600 is taken on a view plane normal to the axis 299 and the y-axis of the reference axes 201.

A shaft 610 may be integrated into the rotor 204, where the shaft 610 is rigidly coupled to the rotor 204. The shaft 610 may be housed and physically coupled to the rotor 204 via the second hole 408, where the shaft 610 may be approximately concentric to the second hole 408. The shaft 610 may be the shaft 208 of FIG. 2.

The rotor core 310 may include a plurality of first ribs 630 that are spoke shaped. Each of the first ribs 630 may be sandwiched between a set of the first holes 440 and the second holes 442. The first ribs 630 may include a plurality of channels 632, where each of the first ribs 630 may include at least a channel of the channels 632. The channels 632 may be volumetrically connected to the third slots 466. The third slots 466 may be positioned radially above or to the top of the first ribs 630. Said in another way, the third slots 466 may be positioned radially outward from the first ribs 630. Each of the third slots 466 and fourth slots 468 may be centered around a common axis with a first rib of the first ribs 630.

The rotor core 310 may include a plurality of second ribs 636 and a plurality of third ribs 638, where each of the second ribs 636 and each of the third ribs 638 are on opposite sides of a third hole of the third holes 444. Said in another way, each third hole of the third holes 444 may be sandwiched between a second rib of the second ribs 636 and a third rib of the third ribs 638. Further, each of the second ribs 636 may be sandwiched between a first hole of the first holes 440 and a third hole of the third holes 444. Likewise, each of the third ribs 638 may be sandwiched between a second hole of the second holes 442 and a third hole of the third holes 444.

The first ribs 630 may prevent or reduce leakage of magnetic flux from the first layer of magnets. Said in another way, the first ribs 630 may prevent or reduce leakage of magnetic flux from the first magnets 416a and the second magnets 416b, such as when arranged in a V-shape and integrated into the rotor 204.

The third magnets 418 may be a first width represented by a plurality of first arrows 652, and the fourth magnets 420 may be a second width represent by a plurality of second arrows 654. The first width of the first arrows 652 may be larger in distance than the second width of the second arrows 654, therein the third magnets 418 may be wider than the fourth magnets 420. Each of the third slots 466 may have a first section that is approximately the same size as or larger than the first width represented via the first arrows 652. Further, each of the third slots 466 may have a second section that is approximately the same size as or larger than the second width represented via the second arrows 654, where the second section is a smaller width than the first section of each of the third slots 466. The third magnets 418 may be housed by the first section. The fourth magnets 420 may be housed by the second section.

Turning to FIG. 7, it shows a view 700 of a sectioned segment 702 of the assembly 402 of FIGS. 4-5. The view 700 may be a may be a sectional view (e.g., cross-sectional view). The view 700 is taken on a view plane normal to the axis 299 and the y-axis of the reference axes 201.

The sectioned segment 702 is a slice of the assembly 402 showing a pole surrounded by an ellipse 712. The ellipse 712 is comprised of a plurality of dashed and curved lines. The pole surrounded by the ellipse 712 may be the first pole surrounded by the third ellipse 552 or the second pole surrounded by the fourth ellipse 554. The sectioned segment 702 includes a first magnet of the first magnets 416a, a second magnet of the second magnets 416b, two different halves of the third magnets 418, and two different halves of the fourth magnets 420. The sectioned segment 702 also includes two different halves of the first ribs 630, a rib of the second ribs 636, and a rib of the third ribs 638.

FIGS. 8A-8C show the sectioned segment 702 during a plurality of modes for the flux regulation system. The magnetic flux is varied by applying a positive d-axis current pulse for re-magnetization and negative d-axis current pulse for de-magnetization. The flux may be varied via changing the current in the stator windings 426. Varying the magnetic flux may transition the sectioned segment 702 between different modes of the plurality of modes. The flux regulation mechanism of the present embodiment occurs in three main modes: mode I, mode II, and mode III. A control system, such as the control system 140 of FIG. 1 or the control system 280 of FIG. 2, may include a controller, such as the controller 141 or the controller 282, that may communicatively couple to the rotor 204. The controller may selectively de-magnetize or re-magnetize one or more first magnets from the first set of magnets and/or one or more second magnets of the second set of magnets of the rotor 204. Said in another way, the controller may selectively de-magnetize or remagnetize the first and second magnets 416a, 416b and/or the third magnets 418. The controller may also reverse magnetize the third magnets 418. When reverse magnetized, the polarity of a magnet or magnets, such as the third magnets, changes. The selective magnetization, de-magnetization, and reverse magnetization of magnets by the controller may transition an electric machine that comprises the rotor 204 and stator 206 between mode I, mode II, and mode III.

FIG. 8A shows the sectioned segment 702 during a first mode 802. The first mode 802 is an example of mode I, where all the magnets, (e.g., the first magnets 416a, second magnets 416b, third magnets 418, and fourth magnets 420) are contributors to flux across the air gap represented by arrows 409 and between the stator 206 and rotor 204. During the first mode 802 a plurality of first flux linkages may be represented by a plurality of first lines 812.

The first flux linkages may direct magnetic current from the stator windings 426 through the stator core 302 and to the rotor core 310 across the gap 308. Current may run via the flux linkages through the rotor core 310 to sets of the first and second magnets 416a, 416b, from the first and second magnets 416a, 416b to the third magnets 418 via the rotor core 310, from the third magnets 418 through the fourth magnets 420, and from the fourth magnets 420 through the rotor core 310. More specifically, the first flux linkages and current may extend through the first ribs 630, the second ribs 636, and the third ribs 638 and around the holes 440, 442, 444. The first flux linkages and current carried therein may also curve around the second hole 408.

During the first mode 802, an electric machine housing the sectioned segment 702 may be referred to as fully magnetized.

FIG. 8B shows the sectioned segment 702 during a second mode 822. The second mode 822 is an example of mode II, where the first layer of magnets and the bottom magnets of the second layer of magnets, (e.g., the first magnets 416a, the second magnets 416b, and the fourth magnets 420) are contributors to flux across an air-gap (e.g., the gap 308 of the distance represented by arrows 309) and between the stator 206 and rotor 204. The first layer of magnets, including the first magnets 416a and second magnets 416b, are fully magnetized. Likewise, the bottom magnets of the second layer of magnets, including the fourth magnets 420, are fully magnetized. The top most magnets of the second layer of magnets, including the third magnets 418, are de-magnetized. During the second mode 822 a plurality of second flux linkages may be represented by a plurality of second lines 832.

The second flux linkages may direct magnetic current from the stator windings 426 through the stator core 302 and to the rotor core 310 across the gap 308. Current may run via the flux linkages through the rotor core 310 to sets of the first and second magnets 416a, 416b, from the first and second magnets 416a, 416b to the fourth magnets 420 via the rotor core 310, and from the fourth magnets 420 through the rotor core 310. More specifically, the second flux linkages and current may extend through the first ribs 630, the second ribs 636, and the third ribs 638 and around the holes 440, 442, 444. The second flux linkages and current may also curve around the second hole 408.

FIG. 8C shows the sectioned segment 702 during a third mode 842. The third mode 842 is an example of mode III, where the main flux magnets of the first layer of magnets are de-magnetized, while the top magnets of the second layer of magnets and the sets of parallel magnets of magnets are reversely magnetized. Said in another way, the first and second magnets 416a, 416b are de-magnetized, and the third magnets 418 are reverse magnetized. Additionally, the fourth magnets 420 remain magnetized. During the third mode 842 a plurality of third flux linkages may be represented by a plurality of third lines 852.

During the third mode 842 the air-gap flux may be reduced to zero or approximately zero, preventing current from flowing from the stator 206 to the rotor 204. During the third mode 842 there may be no or negligible (e.g., within 5% of zero) quantities of flux linkages carrying current from the stator 206 to the rotor 204. For example, there may be a flux linkage represented via a line 852a extending through the stator 206 via the stator core 302 to the air gap represented by arrows 409. However, the flux linkage represented via the line 852a prevented from crossing and linking to the rotor 204 and the rotor core 310 via the air gap represented by arrows 409.

Turning to FIG. 9, it shows a 900 graph. The graph 900 is of a plurality of de-magnetization curves (e.g., traces) of permanent magnetic material that may comprise the magnets housed by and integrated with the rotor 204. FIG. 9 shows a plurality of traces for a plurality of magnetic materials, where the traces showing magnetic flux densities (B) at different magnetic field strengths (H). The magnetic materials may be used for the permanent magnets housed by and integrated in a rotor, such as rotor 204 of FIGS. 2-8C.

The graph 900 includes a first axis 904 and a second axis 906. The first axis 904 is an axis of H in units of kilo-ampere per meter (kA/m). The second axis 906 is an axis of the B in units of Teslas (T). H of the first axis 904 may be the independent variable, and B of the second axis may be dependent on H.

The graph 900 includes a first trace 912, a second trace 914, and a third trace 916. The first trace 912 is of B at different values of H for permanent magnet material or permanent magnets comprised of FeN, such as the first and second magnets 416a, 416b of FIGS. 4-8C. The second trace 914 is of B at different values of H for permanent magnet material or permanent magnets comprised of AINICo₅, such as the third magnets 418 of FIGS. 4-8C. The second trace 914 is of B at different values of H for permanent magnet material or permanent magnets comprised of AINICo₉, such as the fourth magnets 420 of FIGS. 4-8C.

Turning to FIG. 10, it shows a graph 1000 that includes a trace 1012 of magnetic flux with respect to de-magnetizing current through the electric machine. Said in another way the trace 1012 represents magnetic flux of magnetic flux linkages for the electric machine over the magnetizing current for the electric machine. The electric machine is a VFM of the present disclosure, such as an electric machine including the assembly 402 of FIGS. 4-5.

The graph 1000 includes a first axis 1004 and a second axis 1006, where the values of the first axis 1004 are independent, and the values of the second axis 1006 are dependent on the first axis 1004. The first axis 1004 is an axis showing de-magnetizing current for the electric machine in units of Ampere (A). The second axis 1006 is an axis showing the magnetic flux in units of weber or volt seconds (V*s) for flux linkages of the electric machine. The flux linkages of second axis 1006 may be flux linkages represented via the first lines 812, the second lines 832, and the third lines 852 of FIGS. 8A-8B.

The trace 1012 shows that as the de-magnetizing current decreases in magnitude, the magnetic flux increases for the flux linkages of the electric machine. The trace 1012 also shows an electric machine of the present disclosure has an ability to with stand high loading de-magnetization. The electric machine may therein enable full utilization of reluctance torque from the electromagnets of the electric machine (e.g., the end windings 304 and the stator windings 426) while preventing irreversible de-magnetization of permanent magnets of a rotor of the electric machine, such as the magnets 414 of the rotor 204 shown in FIG. 4.

Turning to FIG. 11, it shows a graph 1100. Graph 1100 shows the de-magnetization ratios of the permanent magnets for the electric machine during de-magnetization via a plurality of traces. Said in another way, graph 1100 shows a plurality of traces of de-magnetization curves for the magnetic materials as traces, where the traces show de-magnetization ratios at different de-magnetization currents.

The graph 1100 includes a first axis 1104 and a second axis 1106, where the values of the first axis 1104 are independent, and the values of the second axis 1106 are dependent on the first axis 1104. The first axis 1104 shows the de-magnetizing current for the electric machine in units of Ampere (A). The second axis 1106 shows the de-magnetization ratios (DRs) of the magnets as percentages (%).

The permanent magnets include magnets comprising or including Niron Gen 1, AlNiCo₅, or AlNiCo₉ as magnetic materials. The graph 1100 includes a first trace 1112, a second trace 1114, and a third trace 1116 showing de-magnetization ratios at different de-magnetizing currents. The first trace 1112 shows the de-magnetization ratio at different de-magnetizing currents for magnets or magnetic material comprising or including Niron Gen 1. The second trace 1114 shows the de-magnetization ratio at different de-magnetizing currents for magnets or magnetic material comprising AlNiCo₅. The third trace 1116 shows the de-magnetizing ratio at different de-magnetizing currents for magnets or magnetic material comprising AlNiCo₉. The de-magnetization ratio of AlNiCo₉ increases approximately less compared to the de-magnetization ratios of Niron Gen 1 and AlNiCo₅ with more negative de-magnetizing currents. The de-magnetization ratio of AlNiCo₅ increases approximately more than the de-magnetizing ratio of Niron Gen 1 with more negative de-magnetizing currents.

The graph 1100 includes a first threshold 1132 shown as a dashed line. The first threshold 1132 is a de-magnetization ratio of 100%. The first trace 1112 and the second trace 1114 shows the main magnets comprising Niron Gen 1 and the magnets comprising AlNiCo5, respectively, and may be fully de-magnetized. When magnets comprising Niron Gen 1 and AlNiCo5 are fully de-magnetized, the first trace 1112 and the second trace 1114, respectively, may increase to the first threshold 1132. Reverse magnetization occurs at de-magnetization ratios greater than the first threshold 1132 of 100%. The third trace 1116 shows that that the AlNiCo9 magnet may remain magnetized in case of reverse de-magnetization operation, where the third trace 1116 does not increase to a de-magnetization ratio greater than the first threshold 1132.

Turning to FIG. 12, it shows a graph 1200. Graph 1200 is a radar chart with a plurality of radii (e.g., spokes) arranged around a centerpoint 1234, including a first radii 1212 representing [insert variable], a second radii 1214 representing [insert variable], a third radii 1216 representing [insert variable], a fourth radii 1218 representing [insert variable], a fifth radii 1220 representing [insert variable], a sixth radii 1222 representing [insert variable], a seventh radii 1224 representing [insert variable], an eighth radii 1226 representing [insert variable], and a ninth radii 1228 representing [insert variable]. A plurality of lines 1232 connects the data values of the radii, where the lines 1232 represent different values of magnetic flux (B) in units of T.

The scale of B for the lines 1232 may range from a first threshold to a second threshold of B values, where the first threshold is a maximum and the second threshold is a minimum.

The graph 1200 includes a plurality of traces for different types of permanent magnets and/or permanent magnet materials, including a first trace 1242, a second trace 1244, and a third trace 1246. The first trace 1242 shows the change in B at different radii of graph 1200 for magnets or magnetic material comprising or including Niron Gen 1. The second trace 1244 shows the change in B at different radii of graph 1200 for magnets or magnetic material comprising or including AlNiCo₅. The third trace 1246 shows the change in B at different radii of graph 1200 for magnets or magnetic material comprising or including AlNiCo₉.

The first trace 1242 shows B of magnets or magnetic material comprising or including Niron Gen 1 may remain above the third threshold at radii 1212, 1214, 1216, 1218, 1220, 1222, 1224, 1226, and 1228, but may decrease approaching the shaded region 1236 at radii 1222, 1224, 1226, and 1228. At 1228, the first trace 1242 may be approximately at the shaded region 1236 and equal to the third threshold.

The second trace 1244 shows B of magnets or magnetic material comprising or including AlNiCo₅ may remain greater than the third threshold at radii 1212, 1214, 1216, 1218, 1220, 1222, and 1224 and may decrease approaching the shaded region 1236 at radii 1222, 1224, 1226, and 1228. At 1226, the B of the second trace 1244 may be approximately at the shaded region 1236 and/or equal to the third threshold. At 1228, the B of the second trace 1244 may be approximately within the shaded region 1236 and less than the third threshold.

The third trace 1246 shows B of magnets or magnetic material comprising or including AlNiCo₉ may remain greater than the third threshold at radii 1212, 1214, 1216, 1218, 1220, 1222, 1224, 1226, and 1228, and B of the third trace 1246 may remain approximately constant.

Turning to FIG. 13, it shows the re-magnetization characteristics for an electric machine of the present disclosure in forward and reverse directions via a graph 1300. More specifically, FIG. 13 shows the forward and reverse re-magnetization characteristic for a top most magnet of a circuit of parallel magnets of the present disclosure. The magnet or magnets that are forward and reverse magnetized as shown via graph 1300 may be one or more of the third magnets of FIGS. 4-8D. The electric machine may be an electric machine of the present disclosure, including a rotor, stator, and plurality of magnets of the present disclosure. The rotor, stator, and plurality of magnets be the rotor 204 of FIGS. 2-8C, the stator 206 of FIGS. 2-8C, and the magnets 414 of FIG. 4, respectively.

The graph 1300 includes three axes: a first axis 1304, a second axis 1306, and a third axis 1308, where the values of the first axis 1304 are independent, and the values of the second axis 1306 and third axis 1308 are dependent on the first axis 1304. The first axis 1304 shows the magnetizing current for the electric machine in units of A. The second axis 1306 is an axis showing the magnetic flux in units of weber or V*s for flux linkages of the electric machine. The flux linkages of second axis 1006 may be flux linkages represented via the first lines 812, the second lines 832, and the third lines 852 of FIGS. 8A-8C. The third axis 1308 shows percent difference as percentages (%) between two traces of at least a set of traces of graph 1300. A region of moderate re-magnetization states may be shown via rectangle of dashed lines 1310. The region of moderate re-magnetization may be between a first threshold of current and a second threshold of current. For example, the moderate re-magnetization states of dashed lines 1310, may be between approximately 25 A and 100 A on the first axis 1304 and between approximately 0 and 0.4 V*s on the second axis 1306. Further the moderate re-magnetization states may be narrower with respect to the magnetizing current, such that for this or another example, the moderate re-magnetization states of dashed lines 1310 may between approximately 25 A and 75 A.

Graph 1300 includes a first trace 1322 showing magnetic flux relative to different magnetizing currents during a method of forward re-magnetization of a magnet. Graph 1300 includes a second trace 1324 showing magnetic flux relative to different magnetizing currents during a method reverse re-magnetization of a magnet. For an example, forward re-magnetization of one or more of the magnets represented via the first trace 1322 may occur via a method of transitioning from the second mode 822 of FIG. 8B to the first mode 802 of FIG. 8A. For another example, reverse re-magnetization of one or more of the magnet represented via the second trace 1324 may occur via another method of transition from the second mode 822 of FIG. 8B to the third mode 842 of FIG. 8C. The first trace 1322 and the second trace 1324 show the magnetic flux increases as the magnetic current increases.

Graph 1300 includes a third trace 1326. The third trace 1326 shows percent difference between the first trace 1322 and the second trace 1324 with respect to magnetic current. Each value of percent difference for the third trace 1326 is a difference between a first magnetic flux of first trace 1322 and a second magnetic flux of the second trace 1324 at the same magnetic current divided by larger of the fluxes and multiplied by 100%. The third trace 1326 may be negligible approximately at 0% (below 5%) outside of the moderate re-magnetization states represent via the rectangle of dashed lines 1310. Within moderate re-magnetization states, the difference may be approximately above 0. For example, the percent difference of the third trace 1326 may increase to a peak between 20% and 25% during moderate re-magnetization states as shown within the dashed lines 1310. Said in another way, nearly similar (e.g., approximately the same) re-magnetization performance is attained for forward and reverse re-magnetization with exception to during the moderate re-magnetization states.

Turning to FIG. 14, it shows a graph 1400 showing the de-magnetization ratios at different magnetization current for a plurality of permanent magnets of the present disclosure during magnetization. The graph 1400 includes a first axis 1404 and a second axis 1406, where the values of the first axis 1404 are independent, and the values of the second axis 1406 may be dependent on the first axis 1404. The first axis 1404 shows the magnetizing current for the electric machine in units of A. The second axis 1406 shows the de-magnetizing ratios (DRs) of the magnets as percentages (%). The first axis 1104 of FIG. 11 and the first axis 1404 may be part of the same axis, on opposite sides of 0. Likewise, the second axis 1106 of FIG. 11 and the second axis 1406 may be the same axis.

The permanent magnets include magnets comprising or including Niron Gen 1, AlNiCo₅, or AlNiCo₉ as magnetic materials. The graph 1400 includes a first trace 1422, a second trace 1424, and a third trace 1426 showing de-magnetization ratios at different magnetization currents for specific magnets comprising or including different materials. The first trace 1422 shows the de-magnetization ratio at different magnetizing currents for magnets or magnetic material comprising or including Niron Gen 1. The second trace 1424 shows the de-magnetization ratio at different magnetizing currents for magnets or magnetic material comprising or including AlNiCo₅. The third trace 1426 shows the de-magnetization ratio at different magnetizing currents for magnets or magnetic material comprising or including AlNiCo₉. The de-magnetization ratio of AlNiCo₉ increases approximately less compared to the de-magnetization ratios of Niron Gen 1 and AlNiCo₅ with more negative magnetizing currents. The de-magnetization ratio of AlNiCo₅ increases approximately more than the de-magnetization ratio of Niron Gen 1 with more negative magnetizing currents. The de-magnetization ratios of Niron Gen 1, AlNiCo₅, or AlNiCo₉ decrease toward de-magnetization ratio of 0% the more positive and greater in magnitude the magnetization current is.

The graph 1400 includes the first threshold 1132 shown via a dashed line. To summarize, the first threshold 1132 is a de-magnetization ratio of 100%. Magnetization occurs at de-magnetization ratios less than the first threshold 1132 of 100%. The third trace 1426 shows that that the AlNiCo9 magnet may remain magnetized in case of reverse de-magnetization operation, where the third trace 1426 does not increase to a de-magnetization ratio greater than the first threshold 1132. The first trace 1422 shows the main magnets comprising Niron Gen 1 may be fully de-magnetized at a current at or below a second threshold of magnetizing current. The first trace 1422 shows that Niron Gen 1 may not reverse magnetize and may remain approximately at the de-magnetization ratio of the first threshold for magnetizing currents approaching 0 A that are less than the second threshold of magnetizing current. The second trace 1424 shows the magnets comprising AlNiCo5 may be demagnetized at a magnetizing current equal to a third threshold of magnetizing current. Further, the second trace shows the magnets comprising AlNiCo5 at magnetizing currents less than the third threshold of magnetizing current. When magnets comprising Niron Gen 1 and AlNiCo5 are fully magnetized, the first trace 1422 and the second trace 1424 respectively may decrease below the first threshold 1132.

Turning to FIG. 15, it shows a graph 1500. Graph 1500 shows the electromagnetic forces (back-EMFs) under a maximum magnetization state (MS) and a minimum MS. The electric machine may be operating at the maximum MS during a mode I, such as the first mode 802 shown in FIG. 8A. Likewise, the electric machine may be operating at the minimum MS during a mode III, such as the third mode 842 of FIG. 8C.

The graph 1500 includes a first axis 1504 and a second axis 1506. The first axis 1504 is an axis of time, where time is represented in units of seconds(s). The second axis 1506 is an axis of back-EMF, where back-EMF is represented in units of volts (V). The minimum magnitude of back-EMF is zero as shown allowing for reducing the flux to zero. However, at instant of a back-EMF being zero, the rotor may still carry the magnet flux from a magnet or magnets of the lowest coercivity of the magnetic circuits and the second magnetic layer. For example, at instances of back-EMF being zero, the rotor may carry the magnetic flux of magnet(s) comprising AlNiCo₉.

The graph 1500 includes a first trace 1522 and a second trace 1524. The first trace 1522 represents back-EMF over time during the maximum MS. The second trace 1524 represents back-EMF over time during the minimum MS. Minimum back-EMF is zero or approximately zero as shown allowing for reducing the flux to approximately zero. However, at this instant, the rotor still carries the flux of the AlNiCo₉ magnet (e.g., an AlNiCo₉ magnet flux).

Turning to FIG. 16, energy of torque generated by a VFM of the present disclosure post re-magnetization for different currents is shown via graph 1600. The VFM includes a rotor, a stator, and a plurality of magnets of the present disclosure, such as the rotor 204 of FIGS. 2-8C, the stator 206 of FIGS. 2-8C, and the magnets 414 of FIG. 4, respectively. More specifically, the graph 1600 shows the torque produced at different currents, when current is applied at a first current angle of 30° and a second current angle of 50°.

The graph 1600 includes a first axis 1604 and a second axis 1606. The first axis 1604 show current placed on the magnet in units of ampere (A). The second axis 1606 shows the energy of torque produced via the current through the electric machine in units of newton meters (Nm).

The graph 1600 includes a first trace 1622 of torque produced at different currents for the first current angle of 30° and a second trace 1624 of torque produced at different currents for the second angle 50°. The first angle and second angle are current angles. At a current of 0 A, a greater torque is produced via first trace 1622 compared to the second trace 1624, and therein higher torques may be achieved at an angle of 30° compared to 50°. As the strength of current increases, torque of the second trace 1624 increases at a faster rate than torque of the first trace 1622. When the current is greater than a threshold of current, the torque of the first trace 1622 and second trace 1624 may be approximately equal.

Turning to FIG. 17, it shows a graph 1700 of energy from torque at various angles when the electric machine housing a rotor, stator, and plurality of magnets of the present disclosure operates at a maximum MS. The rotor, stator, and plurality of magnets of the present disclosure may be the rotor 204 of FIGS. 2-8C, the stator 206 of FIGS. 2-8C, and the magnets 414 of FIG. 4, respectively. The graph 1700 shows a change in the energy of torque relative to the angle of the torque. The graph 1700 shows a change in the energy of torque relative to the angle of current. The graph 1700 shows a plurality of traces including a first trace 1722, a second trace 1724, and a third trace 1726.

A first axis 1704 of the graph 1700 represents current angles in degrees (°). A second axis 1706 of graph 1700 represents energy from torque in units of Nm. The angles of the first axis 1704 may be the independent variable, and energy of the second axis 1706 may be dependent the angles.

The first trace 1722 is of energy of a first torque at different and increasing angles, where the first torque is a torque of the permanent magnets (Tpm torque), where the permanent magnets may be the magnets 414. The second trace 1724 is of energy a second torque at different and increasing angles, where the second torque is a reluctance torque (Trel torque). The third trace 1726 is of energy of a third torque at different and increasing angles, where the third torque is a total torque (Ttotal) that is the sum of the first torque and the second torque.

The peak energy of the total torque of the third trace 1726 is within a circular shaded area 1732. The peak energy of torque occurs at a current angle of the first axis 1704 that may be referred to as a peak current angle. At the peak current angle, the torque may be at a maximum. For example, the peak of energy from total torque may be at a current angle of approximately 30°. A current angle of 30° may therein maximize torque while operating the electric machine at maximum MS.

Turning to FIG. 18, it shows a graph 1800 of energy from torque at various angles when the electric machine housing a rotor, stator, and plurality of magnets of the present disclosure operates at a minimum MS. The rotor, stator, and plurality of magnets of the present disclosure may be the rotor 204 of FIGS. 2-8C, the stator 206 of FIGS. 2-8C, and the magnets 414 of FIG. 4, respectively. The graph 1800 shows a change in the energy of torque relative to the angle of current. The graph shows a plurality of traces including a first trace 1822, a second trace 1824, and a third trace 1826.

A first axis 1804 of the graph 1800 represents current angles in °. A second axis 1806 of graph 1800 represents energy from torque in units of Nm. The angles of the first axis 1804 may be the independent variable, and energy of the second axis 1806 may be dependent the angles.

The first trace 1822 shows the energy of a first torque at different and increasing angles, where the first torque is a torque of the permanent magnets (Tpm torque), where the permanent magnets may be the magnets 414. The second trace 1824 shows the energy a second torque at different and increasing angles, where the second torque is a reluctance torque (Trel torque). The third trace 1826 shows the energy of a third torque at different and increasing angles, where the third torque is a total torque (Ttotal) that is the sum of the first torque and the second torque.

The peak energy of the total torque of the third trace 1826 is within a circular shaded area 1832. The peak energy of torque occurs at a current angle of the first axis 1804 that may be referred to as a peak current angle. At the peak current angle, the torque may be at a maximum. For example, the peak of energy from total torque may be at a current angle of approximately 50° (e.g., 50° is the peak current angle). The current angle of 50° may therein maximize torque while operating the electric machine at minimum MS.

Turning to FIG. 19, it shows a graph 1900 of energy from torque over time when an electric machine of the present disclosure is operating at a maximum MS and a minimum MS. The graph 1900 includes a first axis 1904 of time in millisecond (ms), and a second axis 1906 of energy of torque in newton meters (Nm). The electric machine is a VFM of the present disclosure, where the VFM includes a rotor, stator, and plurality of magnets of the present disclosure. The rotor, stator, and plurality of magnets of the present disclosure may be the rotor 204 of FIGS. 2-8C, the stator 206 of FIGS. 2-8C, and the magnets 414 of FIG. 4, respectively.

A first trace 1922 is shown via a solid set of curves, and a second trace 1924 is shown via a dashed set of curves. The first trace 1922 is a trace of energy produced via torque over time when the electric machine is operating at the maximum MS. The second trace 1924 is a trace of energy produced via torque over time when the electric machine is operation at the minimum MS. The first trace 1922 produces consistently higher energy via torque input compared to the second trace 1924. The first and second traces 1922, 1924 are sinusoidal in shape and pattern.

The disclosure also provides support for a rotor of an electric machine, comprising: a first set of magnets having a higher coercivity integrated in at least one slot of the rotor, the magnets arranged in a V-shape in the slot, and a second set of magnets with a lower coercivity, compared to the first set of magnets, the second set of magnets comprising at least one pair of magnets having different grades arranged in parallel in a radial slot of the rotor, wherein the first set of magnets forms a first magnetic layer of the rotor, and the second set of magnets forms a second magnetic layer of the rotor. In a first example of the system, the first set of magnets are integrated in a set of slots including a first slot and a second slot. In a second example of the system, optionally including the first example, a first magnet of the pair of magnets has lower coercivity than a second magnet of the pair of magnets, and the first magnet is arranged in a radially outward direction from the second magnet. In a third example of the system, optionally including one or both of the first and second examples, the first magnet and the second magnet are magnetically coupled in a parallel configuration to form a magnetic current. In a fourth example of the system, optionally including one or more or each of the first through third examples, the first magnet is wider than the second magnet. In a fifth example of the system, optionally including one or more or each of the first through fourth examples, neither of the first set of magnets or the second set of magnets are rare-earth permanent magnets. In a sixth example of the system, optionally including one or more or each of the first through fifth examples, the rotor is free of rare-earth materials. In a seventh example of the system, optionally including one or more or each of the first through sixth examples, the first set of magnets is made of a material comprising Iron-Nitride (FeN). In a eighth example of the system, optionally including one or more or each of the first through seventh examples, the second set of magnets is comprised of a first AlNiCo material of a first grade and a second AlNiCo material of a second grade, the second grade different from the first grade. In a ninth example of the system, optionally including one or more or each of the first through eighth examples, the first AlNiCo material is AlNiCo5 and the second AlNiCo material is AlNiCo9. In a tenth example of the system, optionally including one or more or each of the first through ninth examples, the electric machine comprises a controller communicatively coupled to the rotor and configured to selectively de-magnetize or re-magnetize one or more first magnets of the first set of magnets and one or more second magnets of the second set of magnets. In a eleventh example of the system, optionally including one or more or each of the first through tenth examples, the second set of magnets include a third magnet that remains magnetized when the first magnets or the second magnets are de-magnetized.

The disclosure also provides support for an electric machine, comprising a rotor having a first layer of magnets that is responsible for torque production of the electric machine, and a second layer of magnets that is responsible for a flux regulation of the electric machine, wherein the first layer of magnets have a higher coercivity than the second layer of magnets, and neither of the first layer of magnets or the second layer of magnets include rare-earth permanent magnets. In a first example of the system, the second layer of magnets is comprised of pairs of magnets arranged in parallel in a radial slot of the rotor that are magnetically coupled in a parallel configuration to form a magnetic current. In a second example of the system, optionally including the first example, the first layer of magnets is made of a material comprising Iron-Nitride (FeN), a first magnet of each pair of magnets is made of a first AlNiCo material of a first grade, and a second magnet of the pair of magnets is made of a second AlNiCo material of a second, different grade, the first magnet having a lower coercivity than the second magnet. In a third example of the system, optionally including one or both of the first and second examples, the first magnet is arranged in a radially outward direction from the second magnet. In a fourth example of the system, optionally including one or more or each of the first through third examples, the system further comprises: a controller communicatively coupled to the rotor and configured to selectively de-magnetize or re-magnetize one or more magnets of the first layer of magnets and one or more magnets of the second layer of magnets. In a fifth example of the system, optionally including one or more or each of the first through fourth examples, the flux regulation of the electric machine has three modes, and: in a first mode of the controller, all the magnets of the first layer of magnets and the second layer of magnets are magnetized, in a second mode of the controller, the first layer of magnets and the second magnet of the second layer of magnets are magnetized, and the first magnet of the second layer of magnets is de-magnetized, and in a third mode of the controller, the first layer of magnets is de-magnetized, the first magnet undergoes a reverse magnetization, and the second magnet is magnetized.

The disclosure also provides support for a method for a controller for regulating flux of an electric machine, the method comprising: in a first mode of the electric machine, magnetizing a first layer of magnets arranged in a V-shape in slots of a rotor of the electric machine, and magnetizing a second layer of magnets of the rotor, the second layer of magnets comprising pairs of magnets having different grades arranged in parallel in radial slots of the rotor, in a second mode of the electric machine, magnetizing the first layer of magnets and magnetizing a second magnet of each pair of magnets of the second layer of magnets, and de-magnetizing a first magnet of each pair of magnets of the second layer of magnets, and in a third mode of the controller, de-magnetizing the first layer of magnets, magnetizing the second magnet of each pair of magnets of the second layer of magnets, and generating a reverse magnetization in the first magnet of each pair of magnets of the second layer of magnets, wherein the first layer of magnets is made of a material comprising Iron-Nitride (FeN), each first magnet of the second layer of magnets is comprised of a first alNiCo material of a first grade, and each second magnet of the second layer of magnets is comprised of a second alNiCo material of a second grade, the second grade different from the first grade, and neither the first layer of magnets nor the second layer of magnets include rare-earth permanent magnets. In a first example of the method, for each pair of magnets of the second layer of magnets, the first magnet has a lower coercivity than the second magnet, the first magnet is arranged in a radially outward direction from the second magnet, and the first magnet and the second magnet are magnetically coupled in a parallel configuration to form a magnetic current.

FIG. 1 and FIG. 3 show schematic representations of example configurations of systems with relative positioning of the various components. FIG. 2 and FIGS. 4-8C show example configurations with approximate position. FIG. 2 and FIGS. 4-8C are shown approximately to scale; though other relative dimensions may be used. As used herein, the terms “approximately” is construed to mean plus or minus five percent of the range unless otherwise specified. As used herein, the term “approximately” is construed to mean plus or minus five percent of the range, unless otherwise specified.

FIGS. 1-8C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation). FIGS. 2-10D are shown approximately to scale.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A rotor of an electric machine, comprising:
a first set of magnets having a higher coercivity integrated in at least one slot of the rotor, the magnets arranged in a V-shape in the slot; and
a second set of magnets with a lower coercivity, compared to the first set of magnets, the second set of magnets comprising at least one pair of magnets having different grades arranged in parallel in a radial slot of the rotor,
wherein the first set of magnets forms a first magnetic layer of the rotor, and the second set of magnets forms a second magnetic layer of the rotor.

2. The rotor of claim 1, wherein the first set of magnets are integrated in a set of slots including a first slot and a second slot.

3. The rotor of claim 1, wherein a first magnet of the pair of magnets has lower coercivity than a second magnet of the pair of magnets, and the first magnet is arranged in a radially outward direction from the second magnet.

4. The rotor of claim 3, wherein the first magnet and the second magnet are magnetically coupled in a parallel configuration to form a magnetic current.

5. The rotor of claim 3, wherein the first magnet is wider than the second magnet.

6. The rotor of claim 1, wherein neither of the first set of magnets or the second set of magnets are rare-earth permanent magnets.

7. The rotor of claim 5, wherein the rotor is free of rare-earth materials.

8. The rotor of claim 5, wherein the first set of magnets is made of a material comprising Iron-Nitride (FeN).

9. The rotor of claim 5, wherein the second set of magnets is comprised of a first AlNiCo material of a first grade and a second AlNiCo material of a second grade, the second grade different from the first grade.

10. The rotor of claim 9, wherein the first AlNiCo material is AlNiCo₅ and the second AlNiCo material is AlNiCo₉.

11. The rotor of claim 1, wherein the electric machine comprises a controller communicatively coupled to the rotor and configured to selectively de-magnetize or re-magnetize one or more first magnets of the first set of magnets and one or more second magnets of the second set of magnets.

12. The rotor of claim 11, wherein the second set of magnets include a third magnet that remains magnetized when the first magnets or the second magnets are de-magnetized.

13. An electric machine, comprising a rotor having a first layer of magnets that is responsible for torque production of the electric machine, and a second layer of magnets that is responsible for a flux regulation of the electric machine, wherein the first layer of magnets has a higher coercivity than the second layer of magnets, and neither of the first layer of magnets or the second layer of magnets include rare-earth permanent magnets.

14. The electric machine of claim 13, wherein the second layer of magnets is comprised of pairs of magnets arranged in parallel in a radial slot of the rotor that are magnetically coupled in a parallel configuration to form a magnetic current.

15. The electric machine of claim 14, wherein the first layer of magnets is made of a material comprising Iron-Nitride (FeN), a first magnet of each pair of magnets is made of a first AlNiCo material of a first grade, and a second magnet of the pair of magnets is made of a second AlNiCo material of a second, different grade, the first magnet having a lower coercivity than the second magnet.

16. The electric machine of claim 15, wherein the first magnet is arranged in a radially outward direction from the second magnet.

17. The electric machine of claim 15, further comprising a controller communicatively coupled to the rotor and configured to selectively de-magnetize or re-magnetize one or more magnets of the first layer of magnets and one or more magnets of the second layer of magnets.

18. The electric machine of claim 17, wherein the flux regulation of the electric machine has three modes, and:
in a first mode of the controller, all the magnets of the first layer of magnets and the second layer of magnets are magnetized;
in a second mode of the controller, the first layer of magnets and the second magnet of the second layer of magnets are magnetized, and the first magnet of the second layer of magnets is de-magnetized; and
in a third mode of the controller, the first layer of magnets is de-magnetized, the first magnet undergoes a reverse magnetization, and the second magnet is magnetized.

19. A method for a controller for regulating flux of an electric machine, the method comprising:
in a first mode of the electric machine, magnetizing a first layer of magnets arranged in a V-shape in slots of a rotor of the electric machine, and magnetizing a second layer of magnets of the rotor, the second layer of magnets comprising pairs of magnets having different grades arranged in parallel in radial slots of the rotor;
in a second mode of the electric machine, magnetizing the first layer of magnets and magnetizing a second magnet of each pair of magnets of the second layer of magnets, and de-magnetizing a first magnet of each pair of magnets of the second layer of magnets; and
in a third mode of the controller, de-magnetizing the first layer of magnets, magnetizing the second magnet of each pair of magnets of the second layer of magnets, and generating a reverse magnetization in the first magnet of each pair of magnets of the second layer of magnets;
wherein the first layer of magnets is made of a material comprising Iron-Nitride (FeN), each first magnet of the second layer of magnets is comprised of a first AlNiCo material of a first grade, and each second magnet of the second layer of magnets is comprised of a second AlNiCo material of a second grade, the second grade different from the first grade, and neither the first layer of magnets nor the second layer of magnets include rare-earth permanent magnets.

20. The method of claim 19, wherein for each pair of magnets of the second layer of magnets, the first magnet has a lower coercivity than the second magnet, the first magnet is arranged in a radially outward direction from the second magnet, and the first magnet and the second magnet are magnetically coupled in a parallel configuration to form a magnetic current.
